(19) United States
(12) Patent Application Publication
(10) Pub. No.: US 2009/0237597 A1
(43) Pub. Date: Sep. 24, 2009

(54) COLD-CATHODE FLUORESCENT LAMP, BACKLIGHT UNIT, AND LIQUID CRYSTAL DISPLAY

(76) Inventors: Takashi Maniwa, Osaka (JP); Akiko Nakanishi, Osaka (JP); Kazuhiro Kumada, Hyogo (JP); Masanobu Murakami, Osaka (JP); Taizou Ono, Osaka (JP)

Correspondence Address: SNELL & WILMER L.L.P. (Panasonic), 600 ANTON BOULEVARD, SUITE 1400, COSTA MESA, CA, 92626, US

(21) Appl. No.: 12/067,508

(22) PCT Filed: Sep. 29, 2006
(86) PCT No.: PCT/JP2006/319548

§ 371 Date: Mar. 20, 2008

(30) Foreign Application Priority Data
Oct. 4, 2005 (JP) 2005-291522

(51) Int. Cl. G02F 1/1335; H01J 61/52; G09F 13/04

(52) U.S. Cl. 349/70; 313/42; 362/97.1

(57) ABSTRACT

A cold cathode fluorescent lamp has an improved heat dissipation characteristic without an overall increase in size, and a lead wire thereof does not readily break.

The cold cathode fluorescent lamp (20) includes electrodes (28 and 30) composed of electrode main bodies (28a and 30a) that are located in an interior of a glass bulb (21), a lead wire (28b and 30b), the glass bulb (21) having ends into which the lead wires are sealed, and a heat dissipater (32 and 34) that is provided on an other portion of the lead wire, the other portion being outside the glass bulb 21. The portion of the heat dissipater surrounding the lead wire (28b and 30b) are in contact with the end surfaces (21c and 21d) of the glass bulb, when viewed externally along an extending direction of the lead wire.

### TECHNICAL FIELD

The present invention relates to a cold cathode fluorescent lamp (CCFL), a backlight unit that uses the CCFL as a light source, and a liquid crystal display (LCD) apparatus that includes the backlight unit.

### BACKGROUND ART

A CCFL includes a tube-shaped glass bulb and a cold cathode type electrode sealed in the glass bulb at each end thereof. The electrode includes an electrode main body having a shape of, for example, a closed-bottom tube, and a lead wire attached to the bottom thereof, and one part of the lead wire is sealed to the end of the glass bulb, thus attaching the electrode to the glass bulb.

One example of an apparatus that uses this type of CCFL as a light source is a backlight unit of an LCD apparatus used in LCD televisions, etc. In recent years, there has been a decrease in the diameter of glass bulbs in CCFLs along with a reduction in the thickness of LCD apparatuses, and accordingly, the electrodes (main bodies) are becoming smaller, while the lead wires are becoming thinner.

Meanwhile, there is a tendency for LCD apparatuses not only to be thinner, but also to have increasingly large display panels, requiring a brighter light source and a larger amount of current to be applied to the CCFL.

For this reason, in CCFLs of recent years, the lead wires have an increasingly high electric current density due to the thinning of the lead wires and the increase in applied current, leading to a greater amount of heat generated in the lead wires while the lamp is lit. Note that the amount of heat generated in the electrode main body also increases due to the increase in applied current. This increase in the amount of heat generated by the electrode leads to a rise in the electrode temperature, ultimately leading to a shorter life and reduced efficiency of the lamp.

To suppress the rise in electrode temperature, there has been proposed a CCFL that includes a heat dissipater that has a larger diameter than the lead wire and that is on a portion of the lead wire that is outside the glass bulb, and the surface area has been increased to improve the heat dissipation characteristic (patent document 1).

Patent document 1: Japanese Patent Application Publication No. 2002-190279

### DISCLOSURE OF THE INVENTION

### Problems Solved by the Invention

However, the heat dissipation characteristic of the above CCFL is not sufficient, and the lead wire is easily broken. Specifically, although the heat dissipation characteristic improves when the outer diameter of the heat dissipater is larger than the lead wire and the dissipation surface area is larger in comparison to the lead wire, further enlargement of the heat dissipater (by outer diameter or length) is difficult, since it is necessary to store the CCFL in the backlight unit, ultimately leading to an insufficient heat dissipation characteristic.

Also, since the heat dissipater has been provided on the lead wire that extends out from an end of the CCFL and the lead wire has become thinner, if the heat dissipater touches a nearby member during assembly of the backlight unit, the lead wire breaks easily.

In view of the above, an object of the present invention is to provide a backlight unit and a CCFL that improves the heat dissipation characteristic without an increase in overall size, and furthermore, whose lead wire is not easily broken.

### Means to Solve the Problems

In order to solve the above problems, the present invention is a cold cathode fluorescent lamp including a glass bulb; an electrode including an electrode main body and a lead wire, a portion of the lead wire having been sealed to an end of the glass bulb while the electrode main body is positioned in an interior of the glass bulb; and a heat dissipater provided on an other portion of the lead wire outside the glass bulb so as to, when viewed externally along an extending direction of the lead wire, surround the lead wire and be in contact with an outer surface of the end of the glass bulb.

Since the heat dissipater has direct contact with the ends of the glass bulb, this structure enables increasing the amount of heat that is directly transferred from the glass bulb to the heat dissipater. Also, since the lead wire is located in a polygon when the contact portion between the heat dissipater and the glass bulb is viewed externally along an extending direction of the lead wire, the lead wire is supported in a stable state.

Also, the heat dissipater may be tubular in shape, an end thereof being closed, and a surface of the closed end may be substantially in surface contact with the outer surface of the end of the glass bulb, or the heat dissipater may be columnar in shape, and the end thereof may be in surface contact with the outer surface of the glass bulb.

Furthermore, the heat dissipater may be composed of a conductive material, and the lead wire and the heat dissipater may be integrally formed as one piece. Also, the heat dissipater may conduct electricity and be electrically connected to the lead wire, and a conductive covering may be provided around the end of the glass bulb, the conductive covering being electrically connected to the heat dissipater. In addition, a face of the heat dissipater facing the glass bulb may conform in shape to the outer surface of the end of the glass bulb, and be in contact with the face of the glass bulb. In addition, the heat dissipater may be composed of solder.

Furthermore, the heat dissipater may include a first member composed of solder and a second member composed of a conductor other than solder, the second member being joined to the first member, and the first member may include the face of the heat dissipater that conforms to the shape of the end surface of the glass bulb, or the heat dissipater may include a conductor plate composed of a conductor other than solder, and a solder body that is joined to the solder, and the conductor plate may include the face of the heat dissipater that conforms to the shape of the end face of the glass bulb on a side that is opposite from the solder, and a plurality of through-holes may be formed in the conductor plate.

Also, the lead wire and the heat dissipater may be disposed with an interval therebetween, and be electrically connected to each other via solder, and the solder may be susceptible to melting down in a case of a flow of overcurrent due to joule heat, and furthermore the cold cathode fluorescent lamp may further include an insulation member that hermetically seals an area in the solder around connection portions between the lead wire and the heat dissipater. In addition, the insulation member may be a rosin. Also, the lead wire may include a bulge having a larger outer diameter than an outer diameter of the lead wire, and the bulge may be disposed so as to be in contact with the outer surface of the end of the glass bulb.

Meanwhile, in order to solve the above problem, the present invention is also a backlight unit including the cold cathode fluorescent lamp described above as a light source.

The present invention is also a backlight unit including a plurality of cold cathode fluorescent lamps as a light source; a housing that stores the plurality of cold cathode fluorescent lamps; a plurality of U-shaped lamp holders provided in the housing, each gripping an outer circumference of a different end of the plurality of cold cathode fluorescent lamps; and a lighting circuit for lighting the plurality of cold cathode fluorescent lamps, wherein each of the cold cathode fluorescent lamps is the cold cathode fluorescent lamp of claim 6, each of the lamp holders is electrically connected to the respective one of the cold cathode fluorescent lamps by gripping an outer circumference of a covering thereof, the cold cathode fluorescent lamps have been gripped by the lamp holders so as to be arranged substantially parallel with an interval between two adjacent ones of the cold cathode fluorescent lamps, and a pair of lamp holders that grip the coverings of the two adjacent cold cathode fluorescent lamps on one side arranged substantially parallel are electrically connected to each other.

Alternatively, the present invention is also a backlight unit including a plurality of cold cathode fluorescent lamps as a light source; a housing that stores the plurality of cold cathode fluorescent lamps; a plurality of lamp holders provided in the housing, each holding a different end of the plurality of cold cathode fluorescent lamps; and a lighting circuit for lighting the plurality of cold cathode fluorescent lamps, wherein each of the cold cathode fluorescent lamps is the cold cathode fluorescent lamp of claim 6, each of the lamp holders is electrically connected to the respective one of the cold cathode fluorescent lamps by being in contact with a covering thereof, the cold cathode fluorescent lamps are held by the lamp holders substantially parallel to two adjacent ones of the cold cathode fluorescent lamps with an interval therebetween, and a pair of lamp holders that hold the coverings of the two adjacent cold cathode fluorescent lamps arranged substantially parallel are electrically connected to each other on a grounded side, and a pair of the lamp holders that are in contact with the coverings at another end of the two adjacent ones of the cold cathode fluorescent lamps are connected on a high-voltage side to the lighting circuit.

Furthermore, the present invention is also a liquid crystal display apparatus that includes the backlight unit of claim 16. Note that the “liquid crystal display apparatus” referred to here may be a liquid crystal color television, a liquid crystal monitor for a computer, or a compact display apparatus for portable or in-car use.

### EFFECTS OF THE INVENTION

Since the CCFL pertaining to the present invention can increase an amount of heat transfer from a glass bulb to a heat dissipater, this CCFL enables improvement of a dissipation characteristic without enlarging a lamp diameter. Also, since a lead wire is supported by a contact portion between the heat dissipater and the glass bulb, deformation of the lead wire does not easily occur even when the heat dissipater touches another part etc., thereby reducing occurrences of lead wire breakage.

Even if the heat dissipater touches another part during assembly of the backlight unit, breakage of the electrode lead wire does not easily occur, and since the CCFL described above has been provided as a light source in the backlight unit pertaining to the present invention, improvement of the dissipation characteristic is possible, thereby enabling an improvement in manufacturing yield.

### BRIEF DESCRIPTION OF THE DRAWINGS

FIG. 1 shows an outline of an LCD television 1 pertaining to embodiment 1;

FIG. 2 is a schematic perspective view of a structure of a backlight unit 5 pertaining to embodiment 1;

FIG. 3A is a sectional view showing a structure of a lamp 20 pertaining to embodiment 1, and FIG. 3B shows a contact portion between heat dissipaters 32 and 34 and an end surface of a glass bulb 21;

FIG. 4 is a schematic perspective view of a backlight unit 100 pertaining to embodiment 2, where one part thereof has been cut away to show an interior view;

FIGS. 5A, 5B, and 5C show an exemplary lighting circuit 160 included in the backlight unit 100, where FIG. 5A shows the lighting circuit 160, and FIGS. 5B and 5C show connections between lamps La in the lighting circuit 160;

FIG. 6 is an enlarged sectional view of an end of a lamp 120 pertaining to embodiment 2;

FIG. 7 is an enlarged sectional view of an end of a lamp 200 pertaining to embodiment 3;

FIG. 8 shows a melted solder 222 in a fuse 220;

FIG. 9 shows a variation of embodiment 3;

FIG. 10 shows a relationship between a lamp current Ila and an electrode temperature T;

FIG. 11 is an enlarged view showing an end of a lamp 300 pertaining to variation 1;

FIG. 12 shows a contact portion between a heat dissipater and an end surface of a glass bulb;

FIG. 13 is an enlarged view showing an end of a lamp 310 pertaining to variation 2;

FIG. 14 is an enlarged view showing the end of the lamp 310 pertaining to variation 2;

FIG. 15 shows the contact portion between a heat dissipater and an end surface of a glass bulb;

FIG. 16 is an enlarged view showing an end of a lamp 320 pertaining to variation 3;

FIG. 17 is an enlarged view showing an end of a lamp 340 pertaining to variation 4;

FIG. 18 shows a structure of a heat dissipater 343;

FIG. 19A shows a heat dissipater 360 of variation 4-1,

FIG. 19B shows a heat dissipater 370 of variation 4-2, and

FIG. 19C shows a heat dissipater 380 of variation 4-3;

FIG. 20 is an enlarged sectional view of an end of a lamp pertaining to variation 5;

FIG. 21 is a perspective view of a covering 420 pertaining to variation 6;

FIG. 22A shows a lighting circuit 440, and FIG. 22B shows connections between lamps La in the lighting circuit 440; and

FIG. 23 shows an outline of a lamp 500 pertaining to variation 8.

### DESCRIPTION OF THE CHARACTERS

1 liquid crystal display (LCD) television
3 liquid crystal screen unit
5 backlight unit
10 housing
20 cold cathode fluorescent lamps (CCFL)
21 glass bulb
22 glass tube
28, 30 electrodes
28A, 30A electrode main bodies
28B, 30B lead wires
32, 34 heat dissipaters
44, 46 glass beads

### BEST MODE FOR CARRYING OUT THE INVENTION

Cold cathode fluorescent lamps (hereinafter, referred simply as “lamps”), backlight units and LCD apparatuses pertaining to embodiments of the present invention are described below with reference to the drawings. Note that the drawings of the present invention are schematic diagrams for facilitating understanding of the structure of the backlight units and the lamps, and do not show actual dimensions or proportions.

### Embodiment 1

### 1. Structure of LCD Television

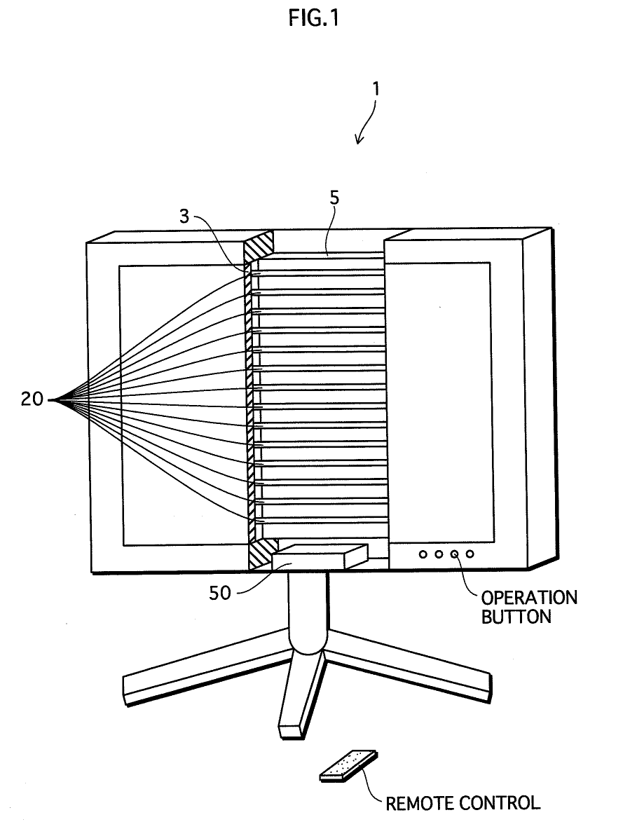

FIG. 1 shows an outline of an LCD television 1 pertaining to embodiment 1.

The LCD television 1 shown in FIG. 1 is one example of an LCD apparatus of the present invention, and is a 32-inch LCD television or the like. The LCD television 1 includes a liquid crystal screen unit 3 and a backlight unit 5.

The liquid crystal screen unit 3 includes a color filter substrate, liquid crystals, a TFT substrate, and a driving module, etc. (not depicted), and forms a color image in accordance with an external image signal.

### 2. Structure of Backlight Unit

Following is a description of the structure of the backlight unit 5.

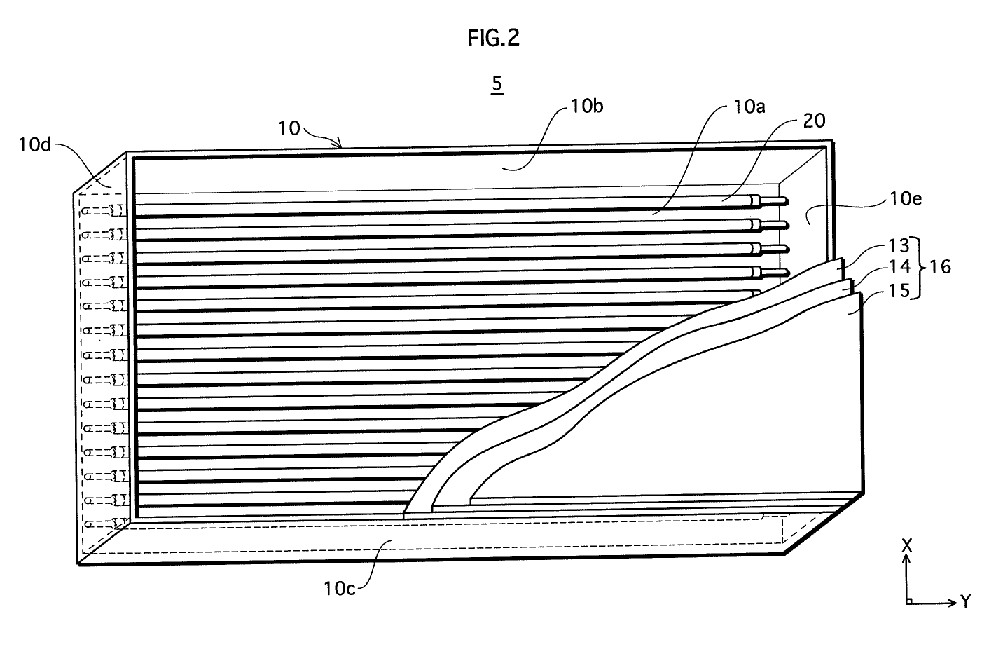

FIG. 2 is a schematic perspective view showing the structure of the backlight unit 5 pertaining to embodiment 1. In order to show the internal structure, a portion of a front panel 16 has been cut away.

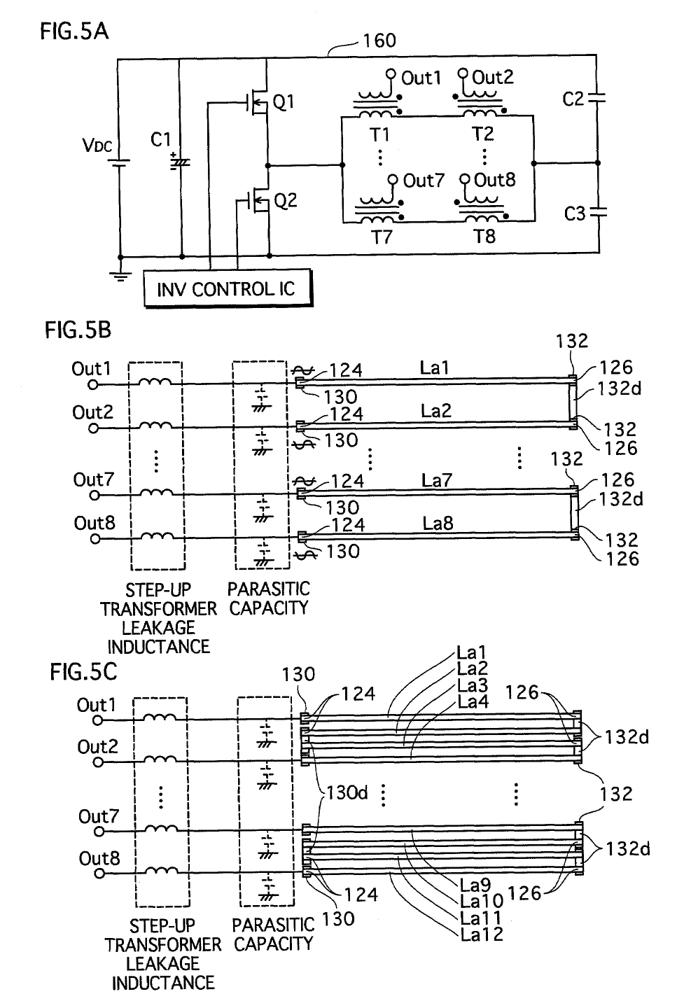

The backlight unit 5 includes, for example, a plurality of (for example, fourteen) cold cathode fluorescent lamps (hereinafter referred to as “lamps”) 20, a housing 10 that stores the lamps 20 and includes an opening, the front panel 16 that covers the opening in the housing 10, and a lighting apparatus 50 that lights the lamps 20 (omitted in FIG. 2, shown in FIGS. 1 and 5A, 5B, and 5C).

The housing 10 is made from, for example, polyethylene terephthalate (PET) resin, and includes a rectangular bottom 10a, and four side walls 10b, 10c, 10d, and 10e that are vertically arranged on the edges of the rectangular bottom 10a. A metal such as silver has been vapor deposited on an inner surface of the housing to form a reflective surface.

Note that the housing 10 may be constituted from, for example, a metallic material such as aluminum or SPCC, instead of a resin. Also, instead of providing the vapor-deposited metal film, a reflective sheet, which is formed from PET resin to which calcium carbonate, titanium dioxide or the like has been added to raise a reflectivity thereof, may be adhered to the side walls and bottom of the housing.

Also, the opening of the housing 10 is covered by the translucent front panel 16 that is formed by laminating a diffusion plate 13, a diffusion sheet 14, and a lens sheet 15, such that foreign substances such as dust and dirt cannot enter the housing.

The diffusion plate 13 is, for example, composed of polymethyl methacrylate (PMMA) resin, and is arranged so as to block the opening of the housing 10. The diffusion sheet 14 is composed of, for example, polyester resin, and diffuses and scatters light that is emitted from the lamps 20. The lens sheet 15 is, for example, an acrylic resin sheet and a polyester resin sheet attached together, and aligns the light in a normal direction of the lens sheet 15. The diffusion plate 13, the diffusion sheet 14, and the lens sheet 15 cause the light emitted by the lamps 20 to radiate evenly forward from the entire surface (light-emitting face) of the front panel 16.

The lamps 20 are fluorescent lamps that use cold-cathode type electrodes, and in the present embodiment, as shown in FIG. 2, fourteen lamps 20 are arranged such that central axes thereof conform to a lengthwise direction of the housing (shown in the drawing as the Y direction). However, the lamps may also be arranged such that central axes thereof conform to the width direction (the X direction) of the housing 10.

### 3. Structure of the Lamp

Following is a description of the structure of the lamps 20.

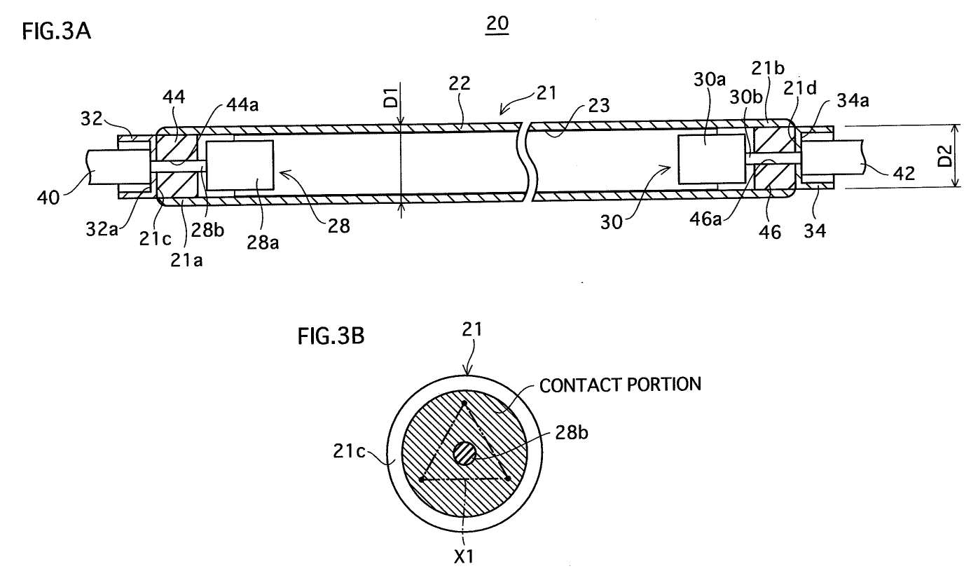

FIG. 3A is a sectional view showing the structure of one of the lamps 20 pertaining to the present embodiment, and FIG. 3B shows the contact portion between heat dissipaters 32 and 34 and an end surface of a glass bulb 21.

The lamp 20 includes the glass bulb 21, formed by sealing both ends of a straight-tube cylindrical glass tube 22, electrodes 28 and 30 that have been sealed to ends 21a and 21b of the glass bulb 21, and the heat dissipaters 32 and 34 provided on portions of the electrodes 28 and 30 outside of the glass bulb 21.

As shown in FIG. 3A, current is supplied to the electrodes 28 and 30 from feeders 40 and 42. Also, note that if, for example, both the ends 21a and 21b of the glass bulb are sealed with use of glass beads 44 and 46 described later, the glass bulb 21 includes the glass beads 44 and 46 in addition to the glass tube 22. If the ends of the glass tube are pinch sealed, the glass bulb 21 only includes the glass tube 22.

The glass tube 22 is composed of, for example, borosilicate glass, and a section (horizontal section) taken along a surface perpendicular to the axis is substantially circular. Note that the glass tube 22 is not limited to borosilicate glass; lead glass, lead-free glass, soda glass, or the like may also be used. This enables improvement of an in-dark start characteristic of the lamp. Specifically, the above glass contains a large amount of an alkali metal oxide typified by sodium oxide (Na₂O), and when sodium oxide is used, for example, the sodium component elutes into an interior surface of the glass bulb as time passes. Since sodium has a low electronegativity, the sodium that elutes into the interior surface of the glass bulb (does not have a protective film) is thought to contribute to an improvement in the in-dark start characteristic of the lamp.

For example, when the alkali metal oxide is sodium oxide, a content ratio between 5 mol % and 20 mol % inclusive is preferable. If the alkali metal oxide comprises less than 5 mol %, the in-dark start time becomes longer, and if over 20 mol %, prolonged use causes problems such as darkening (browning) of the glass bulb leading to reduced brightness, and a decline in the strength of the glass bulb.

Also, using lead-free glass is preferable in consideration of environmental protection. However, there are cases in the manufacturing process of lead-free glass in which lead is included as an impurity. Therefore, lead-free glass is defined as also including glass which includes an impurity level of lead that is less than or equal to 0.1 wt %.

Furthermore, the cross sectional shape of the glass tube 22 is not limited to a circle, and may be another shape, such as an oval.

A discharge medium such as mercury or a rare gas (argon, neon, or the like) has been sealed inside the glass bulb 21 at a predetermined pressure. Note that the discharge medium is filled to a negative pressure.

A phosphor layer 23 has been formed on an inner surface of the glass bulb 21.

The phosphor layer 23, which is constituted from rare-earth phosphor or the like, converts ultraviolet radiation radiated from the mercury to a predetermined wavelength of visible light. As examples of rare-earth phosphors, red (Y₂O₃:Eu³⁺), green (LaPO₄:Ce³⁺,Tb³⁺) and blue (BaMg₂Al₁₆O₂₇:Eu²⁺) can be used.

Note that the phosphor layer 23 is not limited to the above structure. For example, phosphor that absorbs 313-nm ultraviolet radiation such as red phosphor (YVO₄:Eu³⁺), green phosphor (BaMg₂Al₁₆O₂₇:Eu²⁺) and blue phosphor (BaMg₂Al₁₆O₂₇:Eu²⁺, Mn²⁺) may be included.

As described above, using phosphor that absorbs 313-nm ultraviolet radiation for 50 wt % or more of the total phosphor weight almost entirely prevents leakage of 313-nm ultraviolet radiation from the lamp, and use of this lamp in the backlight unit can prevent degradation of the resin or the like used in the front panel 16 due to ultraviolet radiation (see FIG. 2). In particular, polycarbonate (PC) resin, when used for the diffusion plate 13 of the front panel 16, is more easily influenced by 313-nm ultraviolet radiation to degrade and discolor than acrylic resin. Accordingly, including phosphor that absorbs 313-nm ultraviolet radiation in the phosphor layer 23 enables maintaining the attributes of the backlight unit for a long time, even when the backlight unit uses a PC resin diffusion plate.

The definition used here for “absorbing 313-nm ultraviolet radiation” is having a 313-nm excitable wavelength spectrum intensity of 80% or more when the intensity of an approximately 254-nm excitation wavelength spectrum is 100% (the excitation wavelength spectrum is a spectrum in which an excitation wavelength and a light intensity when a phosphor is excited over a range of wavelengths is plotted). In other words, phosphor that absorbs 313-nm ultraviolet radiation is phosphor that can convert 313-nm ultraviolet radiation to visible light.

Examples of phosphor that absorbs 313-nm wavelength ultraviolet radiation are as follows.

Blue phosphor: BaMg₂Al₁₆O₂₇: Eu²⁺, Sr₁₀(PO₄)₆Cl₂:Eu²⁺, (Sr, Ca, Ba)₁₀(PO₄)₆Cl₂:Eu²⁺, Ba_{1-x-y}SrₓEu_{y}Mg_{1-z}Mn_{z}Al₁₀O₁₇ (However, x, y, and z are numbers that satisfy the conditions that 0≦x≦0.4 and 0.07≦y≦0.25, and 0.1≦z≦0.6, and it is especially desirable for z to be such that 0.4≦z≦0.5).

Green phosphor: BaMg₂Al₁₆O₂₇:Eu²⁺, Mn²⁺, MgGa₂O₄:Mn²⁺, CeMgAL₁₁O₁₉:Tb³⁺.

Red phosphor: YVO₄:Eu²⁺, YVO₄:Dy³⁺, (green and red emission).

Note that instead of using only one type of emission color, a mixture using phosphor of a different compound may be used. For example, the following phosphors may be used: for blue, BAM only; for green, LAP (does not absorb 313 nm) and BAM:Mn²⁺; for red, YOX (does not absorb 313 nm) and YVO₄:Eu³⁺.

As shown in FIG. 3A, the electrodes 28 and 30 include electrode main bodies 28a and 30a that are shaped like tubes each having one closed end, and lead wires 28b and 30b, each of which has one end that is fixed to the closed end of one of the electrode main bodies. Note that the electrodes 28 and 30 have the same structures.

The electrode main bodies 28a and 30a here are hollow, and an emitter that is an electron-emitting substance is applied to an inner surface of the tube. For example, a metal such as nickel, niobium, tantalum, molybdenum, and tungsten is used to form the electrode main bodies 28a and 30a, and a carbonate such as barium, strontium, or calcium, an alkali metal oxide, or an alkaline earth metal is used as the emitter.

The lead wires 28b and 30b are composed of a material such as tungsten, and are thinner than the tube-shaped electrode main bodies 28a and 30a. As shown in FIG. 3A, attachment of the electrodes 28 and 30 to the ends 21a and 21b of the glass bulb 21 is achieved by, for example, sealing the outer circumference of the glass beads 44 and 46 to the inner circumference of the ends 21a and 21b of the glass bulb 21 while the lead wires 28b and 30b are inserted into the through-holes 44a and 46a of the glass beads 44 and 46 in a way that forms an airtight seal.

Similar in shape to the electrode main bodies 28a and 30a, the heat dissipaters 32 and 34 are tubes having end walls 32a and 34a on one side, and ends of the lead wires 28b and 30b have been inserted into through-holes that exist in a central part of the end walls 32a and 34a. Note that tungsten or the like can be used to form the heat dissipaters 32 and 34, similarly to the lead wires 28b and 30b.

When viewed externally along an extending direction of the lead wires 28b and 30b, outer surfaces of the end walls 32a and 34a of the heat dissipaters 32 and 34, as shown in FIG. 3B, surround the lead wires 28b and 30b and contact the end surface of the glass bulb 21 (although this contact is actually with the end surfaces of the glass beads 44 and 46, the glass beads 44 and 46 are considered to be included in the glass bulb 21). Specifically, when these contact portions are externally viewed along the extending direction of the lead wire axis (hereinafter referred to as an axial direction), the end walls 32a and 34a of the heat dissipaters 32 and 34 touch the end surfaces 21c and 21d of the glass bulb 21 around the outer circumference (in a circumferential direction) of the lead wires 28b and 30b (substantially around an entirety of the outer surface of the end walls 32a and 34a of the heat dissipaters 32 and 34).

Note that setting an outer diameter D2 of the heat dissipater 32 and 34 smaller than an outer diameter D1 of the glass bulb 21 enables the entire range of the outer surface of the end walls 32a and 34a of the heat dissipaters 32 and 34 to be substantially in contact with the end surfaces 21c and 21d of the glass bulb 21. However, in view of the dissipation characteristic of the heat dissipaters 32 and 34 when the lamps are lit, although the dissipation area becomes larger and the dissipation characteristic improves in proportion to increasing the outer diameter D2 of the heat dissipaters 35 and 36, when the heat dissipaters are larger than the lamps 20, the backlight unit also becomes thick. Accordingly, the outer diameter D2 of the heat dissipaters 32 and 34 is preferably substantially less than or equal to the outer diameter D1 of the glass bulb 21.

### 4. Effects

(1) Breakage of Lead Wires

The lamps 20 having the above structure prevent deformation and breakage of the lead wires 28b and 20b even when the heat dissipaters 32 and 34 touch the walls, etc. of the housing 10, for example, during attachment of the lamps 20 to the housing 10 since the end walls 32a and 34a of the heat dissipaters 32 and 34 provided on one end of the lead wires 28b and 30b are in contact with the end surfaces 21c and 21d of the glass bulb 21.

(2) Dissipation Characteristic

When lit, the lamps 20 described above can transfer heat generated in the lead wires 28b and 30b and the electrode main bodies 28a and 30a from the lead wires 28b and 30b to the heat dissipaters 32 and 34 via the glass beads 44 and 46, and can also transfer heat directly from the lead wires 28b and 30b to the heat dissipaters 32 and 34. For this reason, the heat quantity transferred to the heat dissipaters 32 and 34 is large compared to a case in which for example, as in conventional technology, the heat dissipater is separated from the glass bulb, enabling suppressing thermal elevation in the electrode main bodies 28a and 30a.

Also, since the heat dissipaters 32 and 34 are circular and can dissipate heat not only from an outer peripheral surface but also from an inner peripheral surface, the heat dissipaters 32 and 34 can efficiently dissipate the heat that passed through the lead wires 28b and 30b. Furthermore, since the outer diameter D2 of the heat dissipaters 32 and 34 is substantially equal to the outer diameter D1 of the glass bulb 21, the above effects can be obtained by the lamp 20 without an increase in size.

### Embodiment 2

In embodiment 1, current is supplied to the lamp 20 via contact between the feeders 40 and 42, the heat dissipaters 32 and 34, and the lead wires 28b and 30b. In embodiment 2, a feeder is provided at each end of the glass bulb, and mounting to the lamp housing and feeding to the lamp housing is performed by a socket method.

1. Structure of Backlight Unit

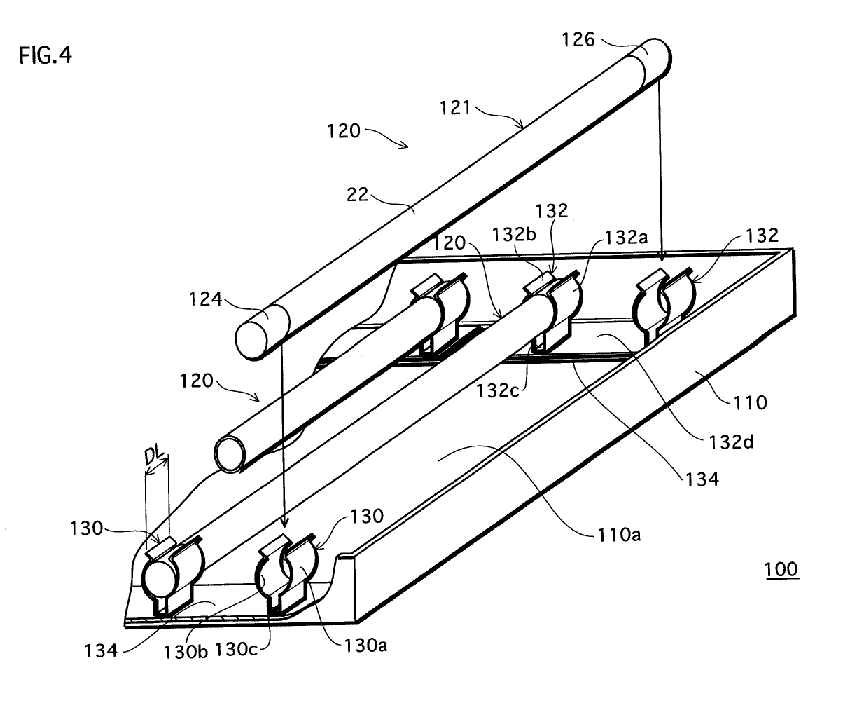

FIG. 4 is a schematic perspective view of a backlight unit 100 pertaining to embodiment 2, where one part thereof has been cut away to show an interior view.

Similarly to embodiment 1, the backlight unit 100 includes a housing 110, a front panel (not depicted), a plurality of lamps 120, and a lighting circuit 160 (see FIG. 5) that lights the plurality of lamps 120.

As shown in FIG. 4, the housing 110 includes sets of U-shaped lamp holders 130 and 132 that are provided on a bottom 110a of the housing 110 and that are disposed in correspondence with the mounting positions of the lamps 120, and the lighting circuit 160 (see FIG. 5) that is, for example, mounted externally to the housing 110, for lighting the lamps 120 connected to the lamp holders 130 and 132. Note that the lamps 120 have feeders 124 and 126 provided on external circumferences of ends of the glass bulb 121 and receive a power supply from the lamp holders 130 and 132 via the feeders 124 and 126.

The lamp holders 130 and 132 have been formed from folded sheets of a conductive material such as stainless steel or phosphor bronze. The lamp holders 130 (132) include clamp plates 130a and 130b (132a, 132b) and a connection piece 130c (132c) that connects the lower edges of the clamp plates 130a and 130b (132a, 132b).

Depressions conforming to the contours of the feeders 124 and 126 of the lamps 120 are provided in the clamp plates 130a, 130b, 132a, and 132b. When the feeders 124 and 126 of lamps 120 are fit into the depressions, the plate spring effect of the clamp plates 130a, 130b, 132a, and 132b holds the lamps 120 in the lamp holders 130 and 132 and electrically connects the lamp holders 130 and 132 to the feeders 124 and 126.

Note that in order to suppress a corona discharge from occurring when the lamps are lit, a width DL of holding portions of the lamp holders 130 and 132 is set to enable only holding areas of the lamps 120 that include the externally provided feeders 124 and 126.

FIGS. 5A, 5B, and 5C show an exemplary lighting circuit 160 included in the backlight unit 100, where FIG. 5A shows the lighting circuit 160, and FIG. 5B shows connections between lamps La in the lighting circuit 160.

The lighting circuit 160 shown in FIG. 5 supplies power to the lamps 120 provided in the backlight unit 100 via the lamp holders 130 and 132.

Here, the lamp holders 130 and 132 hold the plurality of lamps 120 in substantially parallel rows at a predetermined interval, and the lamp holders 132, which hold the feeders 126 on one side of two neighboring lamps 120 (in FIGS. 5B and 5C, the feeder 126 for the lamps La1 and La2, or La7 and La8; etc.), are electrically connected to each other.

As a result, two straight tube-shaped lamps La1 and La2, for example, enable formation of a pseudo-curved tube (U-shaped tube). Along with halving the number of inverters needed, this pseudo-curved tube, in comparison to a lamp having a conventional curve, also reduces luminance irregularities in the longitudinal direction (the axial direction, left and right of the housing interior) of the lamps 120, and furthermore prevents breakage of the attachment portions, etc. of the lamps 120, and enables one-touch mounting or removal of the lamps 120.

Also, since the straight tube-shaped lamps 120 that have electrodes 28, described later, on both ends are arranged vertically for example, the electrodes 28 acting as sources of heat are not concentrated on one side, which prevents temperature differences between right and left sides of the housing interior, as a result suppressing luminance irregularities of the backlight unit 100 caused by mercury vapor pressure in the lamps 120.

Furthermore, as shown in FIG. 4, insulation plates 134, composed of polycarbonate, have been disposed between the lamp holders 130 and 132 and the housing 110 to insulate the lamp holders 130 and 132 and the housing 110 from each other.

Also, the lamp holders 132 that are connected to the feeders 126 of the lamps La1 and La2 and to the feeders 126 of the lamps La7 and La8 in FIG. 5B have been individually soldered to a metal plate 132d.

Note that although each lamp holder 132 is made up of multiple pieces, is U-shaped, and is individually soldered to the metal plate 132d in correspondence with one of the lamps 120, the present invention is not limited to this. The clamp plates 132a and 132b may be formed from one sheet as a single piece, according to a conventional method.

Following is a description of an exemplary lighting circuit 160.

As shown in FIG. 5A, the lighting circuit 160 includes a direct current power source (V_{DC}), switch elements Q1 and Q2 and capacitors C2 and C3 that are connected to the direct current power source (V_{DC}), step-up transformers T1 and T2 (or T7 and T8) that are connected to the connection between the switch elements Q1 and Q2 and the connection between the capacitors C2 and C3, and an inverter control IC that supplies a gate signal for switching the switch elements Q1 and Q2 alternately ON and OFF.

Also, as shown in FIG. 5B, a series resonance circuit is formed by leakage inductance on the secondary side of the transformer and parasitic capacity occurring between transformer output and an inner surface of the housing 110, and between transformer output and the lamps, and the lighting circuit 160 supplies a sinewave current having a phase difference of substantially 180 degrees to the two connected lamps La1 and La2.

Note that although in FIG. 5B, a plurality of lamps La are connected such that the lamp holders 132 holding the feeders 126 at one end of the two adjacent lamps La1, La2 are mutually connected to form a pseudo-curved tube (U-shaped tube), the present invention is not limited to this. The lamp holders 132 may be connected such that, as shown in FIG. 5C, the feeders 124 on one side of a pair of adjacent lamps La or the feeders 126 on the other side are alternately connected. Among the plurality of arranged lamps La (for example, the adjacent lamp pairs La1 and La2, La2 and La3, La3 and La4, La9 and La10, La10 and La11, or La11 and La12, and for ease of understanding, the following description will be limited to the adjacent lamp pairs La1 and La2, La2 and La3, and La3 and La4), the lamp holders 130 and 132 may form a zigzag alignment in the following order. First the feeders 126 of the adjacent lamp pair La1 and La2 are interconnected, then the feeders 124 of the adjacent lamp pair La2 and La3 are interconnected, and next the feeders 126 of the adjacent lamp pair La3 and La4 are interconnected.

Note that in this case, as shown in FIG. 5C, the lamp holders 132 on the feeders 126 of the lamps La1, La2, and so on are connected to each other via the metal plate 132d. Also, the lamp holders 130 on the feeders 124 of the lamps La2, La3, and so on are connected to each other via a metal plate 130d.

As well as enabling a further reduction in the number of inverters, this structure enables harness processing to be executed merely by using a zigzag alignment of lamp holders 130 and 132. In other words, a reduction in harness processing is possible since the lamp holders 130 and 132 do not require harness processing from the lighting circuit.

2. Structure of the Lamp

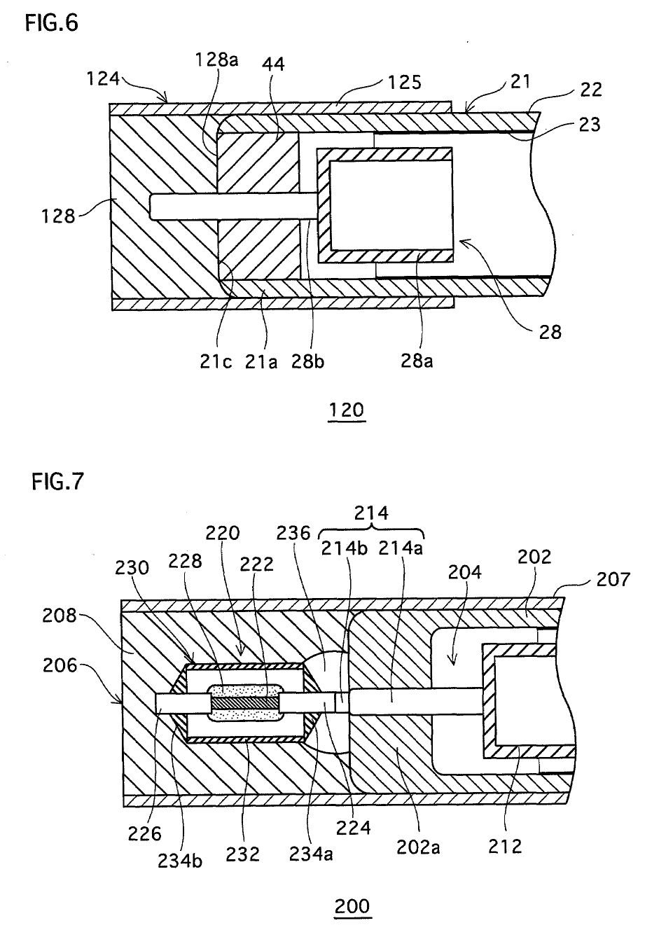

FIG. 6 is an enlarged sectional view of an end of a lamp 120 pertaining to embodiment 2. Note that constituent elements having similar structures to embodiment 1 have been given the same reference notations.

Similarly to embodiment 1, the lamp 120 includes the glass bulb 21, an electrode 28(30) that has been attached at an end 21a(21b) of the glass bulb 21, a covering 125 (125) that covers the end 21a (21b) of the glass bulb 21 and extends further outward than the end 21a(21b) of the glass bulb 21, and a heat dissipater 128 (128) in the feeders 124 and 126 that is provided around a lead wire 28b(30b) extending from an end surface 21c(21d) of the glass bulb 21.

The heat dissipater 128 (128), which is a conductive material, fits in the space enclosed by the covering 125, and electrically connects the feeder 124 (126), the covering 125(125) and the lead wire.

Note that although only one side of the lamp 120 (the feeder 124 side) is depicted in FIG. 6, an electrode similar to the one in embodiment 1 has also been provided on the other side, and similarly to the depicted side, and the feeder 126 including the covering 125 and the heat dissipater 128 has also been provided on the other end. Also, as in embodiment 1, mercury, rare gases and the like are sealed inside the glass bulb 21, and a phosphor layer 23 has been formed on the inner surface of the glass bulb 21.

Similarly to embodiment 1, the electrode 28(30) includes an electrode main body 28a(30a) and a lead wire 28b(30b). The heat dissipater 128(128) is in an inner portion of the covering 125(125), and has been formed by filling solder or the like in an area that spans from the end surface 21c(21d) of the glass bulb 21 to an outward edge of the covering 125(125) in an axial direction of the lamp. Note that the heat dissipater 128(128) is formed with the lead wire 28b(30b) embedded substantially in a center thereof, and an end 128a(128a) thereof is in contact with the end 21c(21d) of the glass bulb 21.

As described above, a conductive material (solder) is used for the heat dissipaters 128, and when the lamps 120 are mounted in the lamp holders 130 and 132, the covering 125 receives a feed from the lamp holders 130 and 132, as a result of which current flows to the electrode main bodies 28a and 30a. Note that a material (metal) having good conductivity is used since, in this way, the covering 125 must conduct a current.

3. Effects

(1) Breakage of the Lead Wire

Similarly to embodiment 1, since the lead wire 28b is buried in the heat dissipater 128 (128) and has surface contact with the end face 21c(21d) of the glass bulb 21, breakage, etc. of the lead wire 28b (30b) is reduced in the lamps 120 pertaining to embodiment 2 even when the heat dissipaters come into contact with the walls of the housing 110.

(2) Heat Dissipation Characteristic

When the lamps 120 described above are lit, heat generated in the lead wire 28b(30b) and the electrode main bodies 28a(30a) is transferred from the lead wires 28b(30b) to the heat dissipater 128(128) via the glass beads 44(46), and heat can also be transferred from the lead wires 28b(30b) directly to the heat dissipater 128(128), and furthermore can be transferred from the heat dissipater 128(128) and the glass beads 44(46) to the covering 125(125).

Thus, a greater amount of heat is transferred to the heat dissipater 128(128) and the covering 125(125) than in conventional technology, in which the heat dissipater is apart from (not touching) the glass bulb, thereby enabling commensurately better suppression of thermal elevation in the electrode main body 28a(30a).

### Embodiment 3

Although the lamp 120 of embodiment 2 includes the glass bulb 21, the electrode 28(30), and the feeders 124 and 126, another member may be included as well.

The following describes a case in embodiment 3 in which a fuse is included as an additional member.

1. Structure

FIG. 7 is an enlarged sectional view of an end of a lamp 200 pertaining to embodiment 3.

The lamp 200 includes a glass bulb 202, an electrode 204, a covering 207, a heat dissipater 208, and a fuse 220.

Here, the electrode 204 includes an electrode main body 212 and a lead wire 214, and the lead wire 214 is composed of a large-diameter part 214a and a small-diameter part 214b that is thinner than the large-diameter part 214a. The large-diameter part 214a is formed in an area of the lead wire 214 from a connection between the electrode main body 212 and the lead wire 214 to an outer end of a sealing part 202a of the glass bulb 202. Furthermore, the small-diameter part 214b is formed in an area of the lead wire 214 that extends externally from the glass bulb 202.

A fuse 220 has been mounted to an outer end of the lead wire 214, that is, to the outer end of the small-diameter part 214b. Note that the lead wire 214 and the fuse 220 are electrically connected.

As shown in FIG. 7, in the fuse 220, a pair of terminal lead wires 224 and 226 are connected via a solder 222, and the terminal lead wire 224 is connected to the lead wire 214 in a substantially straight line. Note that the lead wire 214 and the lead wire 224 have been connected by soldering or the like.

A rosin 228 coats the solder 222 and a connection between the solder 222 and the terminal lead wires 224 and 226. Also, an insulation case 230 hermetically seals the solder 222. The insulation case 230 includes a tube 232 and lids 234a and 234b that block the openings of both sides of the tube 232.

Here, the terminal lead wires 224 and 226 are constituted from nickel wires for example, and a composition of the solder 222 is, for example, Sn: 96.5%, Ag: 3.0%, and Au: 0.5% solder. The melting point of the solder is approximately 220° C. The tube 232 is made of a ceramic material for example, and the lids 234a and 234b are made from resin (epoxy resin), for example.

Similarly to embodiment 2, a metallic sleeve is used as the covering 207 to cover an end (202a) of the glass bulb 202 so that an end thereof protrudes outward.

Except for the insulation space 236, a space enclosed by the part of the covering 207 that protrudes from the end (202a) of the glass bulb 202 is filled by a heat dissipater 208 that is made of solder or the like. According to this structure, the heat dissipater 208 ensures power conductivity between the terminal lead wire 226 and the feeder 206, and the feeder 206 is formed as a result.

Note that the insulation space 236 is provided in order to prevent electricity from flowing from the small-diameter part 214b of the lead wire 214 and the terminal lead wire 224 to the covering 207 via the heat dissipater 208 and also to channel current to the solder 222 in the fuse 220.

The solder 222 melts down when the current flowing therein exceeds a predetermined value and becomes overcurrent, thus breaking the feed (power distribution) from the feeder 206 to the electrode 204.

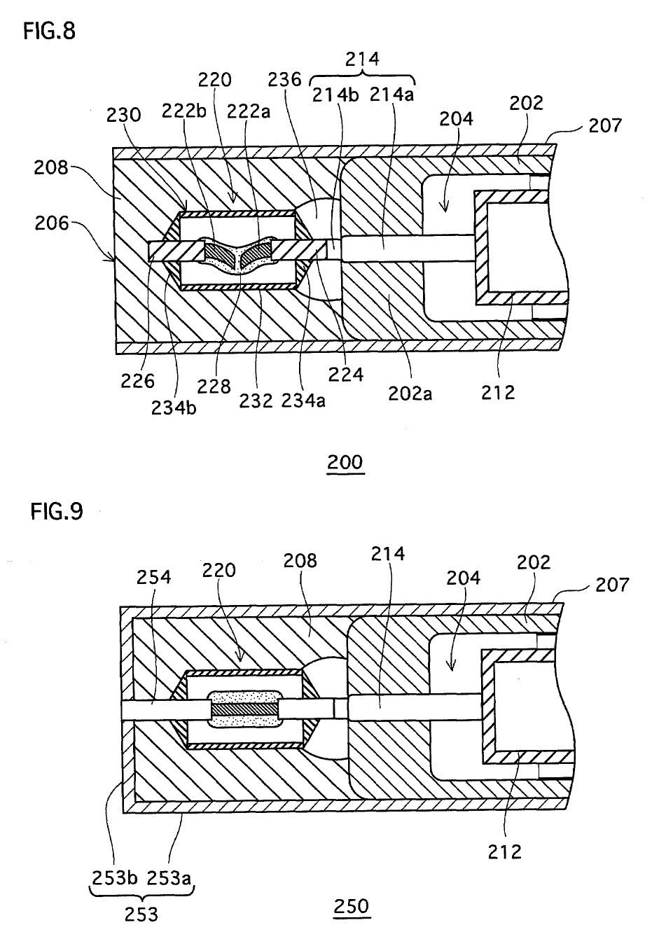

FIG. 8 shows the solder 222 that has melted down in the fuse 220.

As shown in FIG. 8, when an overcurrent flows into the solder 222, the solder 222 melts down and divides into a solder 222a and a solder 222b. The divided solder 222a and 222b are still covered by the rosin 228.

Since the rosin 228 is an insulating material, the terminal lead wire 224 and the terminal lead wire 226 are electrically insulated from each other. Even if a voltage is applied to the feeder 206, current will not flow into the lead wire 214, since the feeder 206 and the lead wire 214 are electrically insulated from each other.

Also, ozone production is prevented, since a discharge (corona discharge) is not generated between the solders 222a and 222b after meltdown due to being coated by the insulating rosin 228.

Even in a case in which the solders 222a and 222b are not covered by the rosin 228 and are exposed, and a discharge occurs between the solders 222a and 222b, the oxygen in the air does not become ozone due to the discharge since the space around the junctions between the terminal lead wires 224 and 226 and the solders 222a and 222b has been sealed by the insulation case 230. Accordingly, ozone production is prevented.

Note that although in embodiment 3, the covering 207 is a sleeve shape, another shape such as a cap shape may be used. The following briefly describes this as a variation of embodiment 3.

FIG. 9 shows a variation of embodiment 3.

Similarly to embodiment 3, a lamp 250 of the variation includes the glass bulb 202, the electrode 204, a covering 253, the heat dissipater 208, and the fuse 220.

As shown in FIG. 9, the covering 253 has a cap shape, and includes a tube part 253a and a bottom part 253b that blocks one end of the tube part 253a. In the present variation, the terminal lead wire 254 that is not connected to the lead wire 214 in the fuse 220 has been fitted into a through-hole in the bottom part 253b. Note that the terminal lead wire 254 and the covering 253 may be either electrically connected or not electrically connected.

2. Dissipation Effect

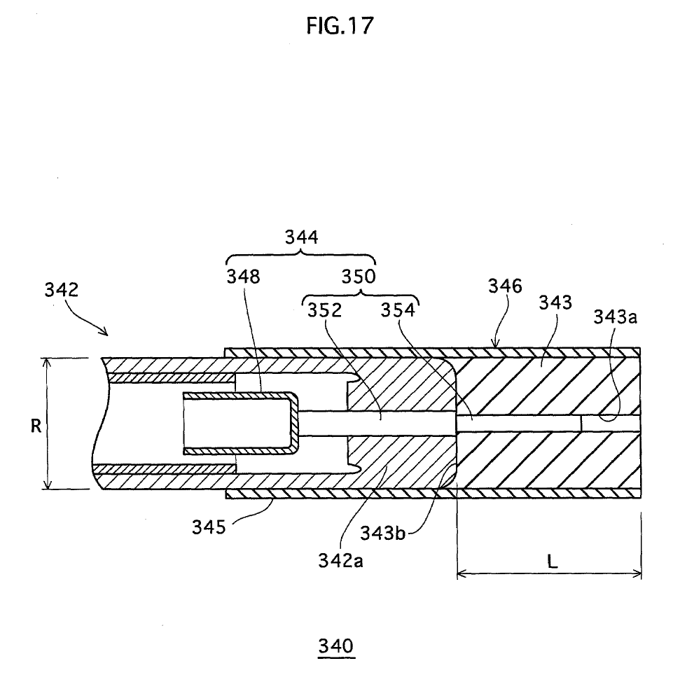

The inventors performed a validation test concerning the effect of the heat dissipater. Specifically, the inventors performed a test with use of a lamp in which a lead wire 350 (outer lead part 354) of an electrode shown in FIG. 17 that is described later as variation 4 has been extended to an end surface of a heat dissipater 343.

Following is a description of the basic structure of the lamp used in the test. The outer diameter R of a glass bulb 342 is 3.0 mm, and the total length of the lamp is 417 mm. The lead wire 350 of the electrode includes an inner lead part 352 whose outer diameter is 1.0 mm, and the outer lead part 354 whose outer diameter is 0.8 mm. The total length of the covering 345 is 7.5 mm, and a heat dissipater 343 is provided in all the remaining space enclosed by the covering 345 that is covering the glass bulb 342.

Note that an electrode main body 348 is made of nickel, and in the lead wire 350, the inner lead part 352 is made of tungsten, and the outer lead part 354 is made of nickel. The heat dissipater 343 is constituted from solder, and the covering 345 is made of an iron-nickel alloy.

In the test, the amount that the covering 345 extends from the end surface of the glass bulb 342, that is, “L” of FIG. 17, was either 0.5 mm, 1.0 mm, or 1.5 mm, and one of each type of lamp was manufactured. With use of these three lamps, the relationship between the lamp current and the temperature of the electrode main body was measured and the effect of the heat dissipater was checked.

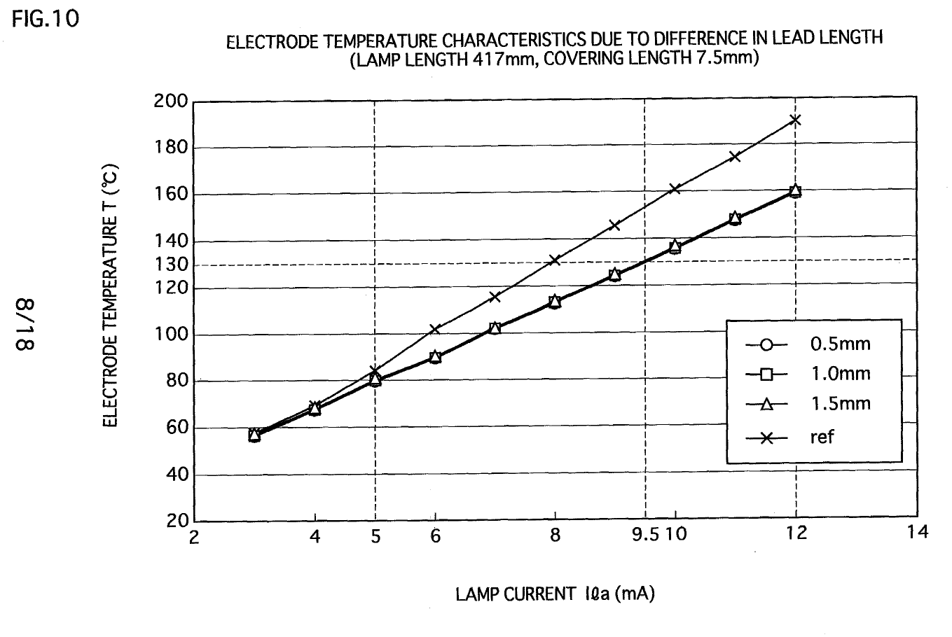

FIG. 10 shows a relationship between lamp current Ila and electrode temperature T.

In FIG. 10, the result of a lamp having an “L” of 0.5 mm is designated by a circle “O”, the result of a lamp having an “L” of 1.0 mm is designated by a square “□”, and the result of a lamp having an “L” of 1.5 mm is designated by a triangle “Δ”. Note that in order to check the above heat dissipation effect, the test was similarly performed on a lamp that does not include a sleeve or a heat dissipater and whose outer lead part length is 1.5 mm, and this result is depicted in FIG. 10 as “x ref”.

In the lamps that are provided with a heat dissipater, and in the lamp that is not provided with a covering or a heat dissipater, the electrode temperature T rises in accordance with an increase in the lamp current Ila. However, in comparison to the lamp that is not provided with a covering or a heat dissipater, the lamp that is provided with a heat dissipater clearly has a lower rise in the electrode temperature T in accordance with the increase in the lamp current Ila (a smaller temperature gradient).

Also, when the lamps including heat dissipaters are compared to each other, the rise in temperature in accordance with an increase in lamp current Ila is substantially the same. The lack of a large difference between the heat dissipation effect of the lamps is thought to be due to the fact that there is no change in the contact area between the heat dissipater and the glass bulb, even if the amount of protrusion (L) of the covering from the end of the glass bulb changes within a range of L values in the test.

The lamp pertaining to the present invention is preferably used such that when lit, the lamp current Ila is in a range between 5 mA and 12 mA inclusive. The reason for this is that the effect of the heat dissipater cannot be obtained (that is, the dissipation characteristic is the same as a lamp that does not include a heat dissipater) if the lamp current Ila is less than 5 mA. On the other hand, if the current Ila is greater than 12 mA, the temperature of the electrode rises too high, incurring a risk that the solder constituting the heat dissipater will melt down.

Note that the lamp current Ila is even more preferably in a range between 5 mA and 9.5 mA inclusive. A case in which the lamp current Ila is below 5 mA has the same issue as above. On the other hand, if the lamp current Ila is greater than 9.5 mA, the electrode temperature Twill reach or exceed 130° C., depletion of the electrode main body will become extreme due to sputter, and the lamp efficiency will decrease.

Although described based on the above embodiments, the present invention is of course not limited to the concrete examples of such embodiments. Variations such as the following are also included in the present invention.

### Variations

1. The Heat Dissipater

(1) Shape

In the embodiments, the end surface of the heat dissipater on the glass bulb side is flat. This is because the end surface of the glass bulb (glass bead) is flat and substantially orthogonal to the central axis of the glass bulb, and the end surface of the heat dissipater is flat for the purpose of establishing surface contact with the flat end surface of the glass bulb. Note that the reason for establishing surface contact is to enlarge the contact area between the heat dissipater and the glass bulb, and to prevent deformation of the lead wire.

However, the end surface of the glass bulb may have a shape other than the flat shape orthogonal to the central axis of the glass bulb. In such a case, the end surface of the heat dissipater on the glass bulb side, rather than having a flat shape, preferably conforms to the shape of the glass bulb end surface, in order to establish surface contact between the heat dissipater and the glass bulb end surface. Following is a description of variations pertaining to shapes of the heat dissipater.

(1-1) Variation 1

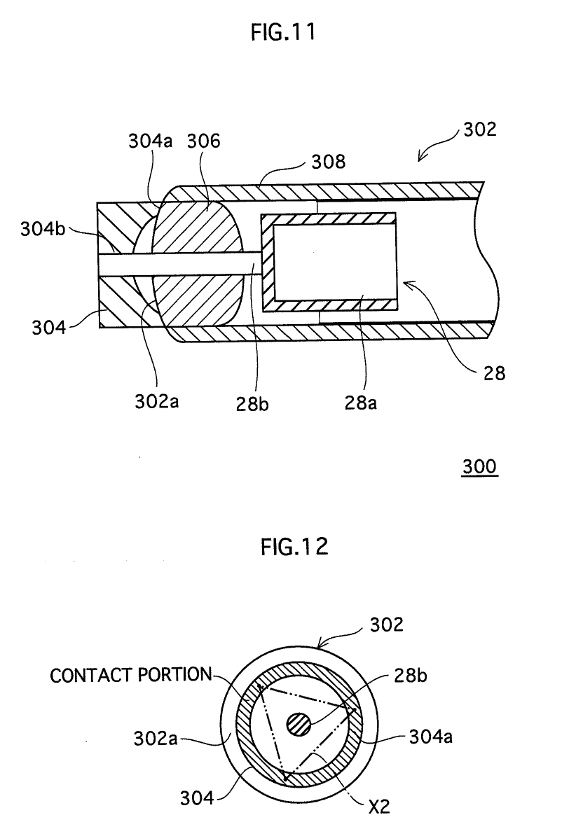

FIG. 11 is an enlarged view showing an end of a lamp 300 pertaining to variation 1. Note that one end side of the lamp 300 is described in variation 1, and the structure of the other end is similar to the one end side.

Similarly to embodiments 1 to 3, the lamp 300 of variation 1 includes a glass bulb 302, the electrode 28 and a heat dissipater 304.

Similarly to embodiments 1 to 3, the electrode 28 includes an electrode main body 28a and a lead wire 28b, and the lead wire 28b is sealed in an end of the glass bulb 302 via a glass bead 306. Here also, the glass bulb 302 is composed of a glass tube 308 and the glass bead 306.

Although the glass bulb 302 is basically the same as the glass bulb of the embodiments 1 to 3, the glass bead 306 differs from the shape described in embodiments 1 to 3, and has a shape of an arc protruding outwardly. Accordingly, the end face 302a of the glass bulb 302 has an arc shape similar to the end surface shape of the glass bead 306.

Similarly to embodiments 1 to 3, the heat dissipater 304 is provided around the lead wire 28b of the electrode 28 outside of the glass bulb 302.

FIG. 12 shows a contact portion between the heat dissipater and the end surface of a glass bulb.

As shown in FIG. 11, the heat dissipater 304, is substantially columnar, and the end on the glass bulb 302 side is depressed inwards in an arc shape that has a smaller curvature than the arc shape of the end surface 302a of the glass bulb 302. Also, as shown in FIG. 12, the heat dissipater 304 has contact (surface contact) with the end surface 302a of the glass bulb 302 (the contact part in FIG. 12) on the circumference of a predetermined radius (having a predetermined width) having the lead wire 28b as a center.

Specifically, the heat dissipater 304, when viewed externally along the extending direction of the lead wire 28b is in contact with the entire circumference (while surrounding the lead wire 28b) of the end surface 302a of the glass bulb 302 around the lead wire 28b. In particular, the portions having surface contact, as shown in FIG. 12, when viewed externally along the extending direction of the lead wire 28b, include apexes of a virtual triangle X2 of which the lead wire 28b is located in a center.

This structure enables suppressing deformation of the lead wire 28b, even in a case in which, for example, the heat dissipater 304 comes into contact with a surrounding member when mounting the lamp 300 in the housing. Needless to say, the structure also enables efficient transfer of the heat generated in the lit lamp from the electrode 28 to the heat dissipater 304.

The attachment of the heat dissipater 304 to the glass bulb 302 is achieved by, for example, when the end of the glass bulb 302 has been slightly melted by heating, pressing the heated portion into a mold that is depressed inwardly in an arc having a predetermined curvature, thereby forming the end shape of the glass bulb 302 into a predetermined arc. Then, a lead wire aperture (hole) in the pre-manufactured heat dissipater 304 is heat-fitted around the lead wire 28b and the end surface 304a of the heat dissipater 304 is pushed against the glass bulb 302.

Note that in variation 1, as shown in FIG. 12, the heat dissipater 304 has surface contact with the end surface 302a of the glass bulb 302, and for example, even if the heat dissipater is in linear contact with an entire circumference of the end of the glass bulb around the lead wire, a similar dissipation effect is obtained, though inferior to the dissipation effect in variation 1. Specifically, the amount of heat transferred to the heat dissipater from the electrode in this case is smaller than a case in which the heat dissipater has surface contact with the glass bulb 302 as in the above variation 1, but greater than a case in which the heat dissipater is not in contact with the glass bulb.

(1-2) Variation 2

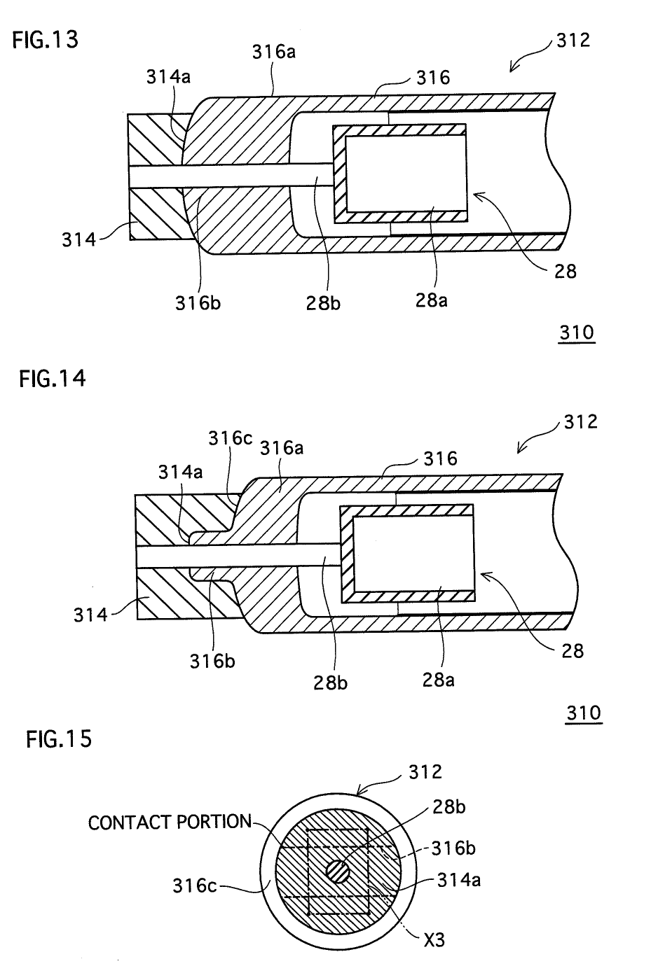

FIGS. 13 and 14 are enlarged views showing an end of a lamp 310 pertaining to variation 2. Note that one end side of the lamp 310 is described in variation 2, and the structure of the other end is similar to the one end side.

FIG. 13 shows the end of the glass bulb sectioned along a surface perpendicular to a direction of pinch sealing when viewed from the direction of pinch sealing. FIG. 14 shows the end of the glass bulb sectioned along a surface parallel to a direction of pinch sealing when viewed from a direction perpendicular to the direction of pinch sealing.

Similarly to embodiments 1 to 3 and variation 1 (hereinafter to be referred to collectively as “embodiments, etc.”) the lamp 310 pertaining to variation 2, similarly to embodiments 1 to 3 and variation 1 (hereinafter to be referred to collectively as “embodiments and variations”) includes a glass bulb 312, the electrode 28 and a heat dissipater 314.

Similarly to the embodiments, etc., the electrode 28 includes an electrode main body 28a and a lead wire 28b. Pinch-sealing an end of the glass tube 316 while the electrode main body 28a is inserted into the glass bulb 312 seals the glass bulb 312. Note that here, the glass bulb 312 is composed of the glass tube 316.

Since the end 316a of the glass tube 316 is pinch sealed (the sealed portion is designated as “316b”), the end shape of the glass bulb 312 is different from the embodiments etc. described above.

The heat dissipater 314 is on a portion of the lead wire 28b of the electrode 28 that is outside the glass bulb 312, and is provided so as to contact an end surface 316c of the glass bulb 312 (the glass tube 316).

The heat dissipater 314 is substantially columnar, and the end surface 314a on the glass bulb 312 side conforms to the shape of the end surface 316c of the glass bulb 312, and a portion corresponding to the sealed part 316b of the glass bulb 312 is depressed.

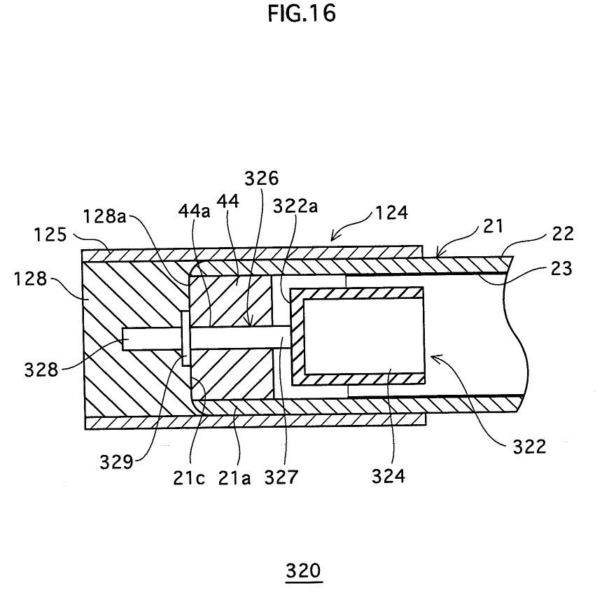

FIG. 15 shows contact portions between the heat dissipater and the end surface of a glass bulb.

As shown in FIG. 15, the heat dissipater 314 is in surface contact with the end surface 316c of the glass bulb 312 and the sealed part 316b, while facing (in the drawing, facing up and down) and sandwiching the sealed part 316b of the glass bulb 312. Also, as shown in FIG. 15, the portions in surface contact, when viewed externally along the extending direction of the lead wire 28b, surround the lead wire 28b. In other words, the portions that have surface contact include the apexes of a virtual square X3 of which the lead wire 28b is located in a central inner portion.

This structure enables suppressing deformation of the lead wire 28b, even in a case in which, for example, the heat dissipater 314 comes into contact with a surrounding member when mounting the lamp to the housing. Needless to say, the structure also enables efficient transfer of the heat generated in the lit lamp from the electrode 28 to the heat dissipater 314.

For example, the heat dissipater 314 can be realized by disposing, on the end of the glass bulb 312, a ring-shaped mold whose inner diameter is equal to the outer diameter of the heat dissipater 314, and filling the mold with melted solder.

(1-3) Other variations

The glass bulb of variation 1 or 2 can also be used in the lamp of embodiment 2. In this case, any one of the heat dissipaters described in embodiments 2 or 3 etc., or in variation 1 can be used. Furthermore, the feeder of embodiment 2 or 3, etc. may be provided at the end of the glass bulb in variations 1 and 2.

(2) Relationship to the Lead Wire

Although the heat dissipater of the embodiments, etc. is separate from the lead wire, the heat dissipater and the lead wire may also be integrally formed as one piece. For example, a heat dissipater integrally formed using the same material as the lead wire may have the same structure as the heat dissipater described in the embodiments and variations etc., and be formed at an end of the lead wire that is on an opposite side from the electrode main body. Note that when the lead wire and the heat dissipater are separately formed, the same material can be used for both, or a different material may be used for each.

(3) Contact Between the Heat Dissipater and the Glass Bulb

In the embodiments, etc., the contact portions between the heat dissipater and the glass bulb are such that, when viewed externally along the extending direction of the lead wire, either surface contact or linear contact is achieved between the heat dissipater and the glass bulb, and the contact portion includes the apexes of a virtual polygon of which the lead wire is located in an inner center, so that the lead wire is not likely to deform even when something comes into contact with the end of the lamp. However, as long as deformation of the lead wire is merely suppressed in some way, the heat dissipater and the glass bulb do not need to have surface or linear contact with each other.

For example, the heat dissipater may touch three or more points on the end surface of the glass bulb where the lead wire is located internally on the end surface of the glass bulb, and the lead wire may be located within a virtual polygon (a polygon having three or more sides) that connects the points of contact. Note that the contact portions between the heat dissipater and the glass bulb of the embodiments and variations, needless to say, include the three points mentioned above.

2. Electrode

Although the lead wire of the electrode in embodiment 2 is substantially rod-shaped (unstepped), other shapes may be used. Another shape is described as variation 3.

FIG. 16 is an enlarged view showing an end of a lamp 320 pertaining to variation 3.

The structure of the lamp 320 is basically the same as the lamp 120 of embodiment 2, and includes the glass bulb 21, an electrode 322, a heat dissipater 128, and the covering 125.

The electrode 322 includes an electrode main body 324 and a lead wire 326 that is connected to the electrode main body 324. The lead wire 326 includes an inner lead part 327, an outer lead part 328, and a bulge 329 located between the inner lead part 327 and the outer lead part 328.

The inner lead part 327 includes a portion that is attached to the glass bead 44 and a portion that extends from the glass bead 44 into the glass bulb 21. The outer lead part 328 is constituted from a portion in which the central axis of the inner lead part 327 is extended from the bulge 329 to an exterior of the glass bulb 21.

The bulge 329 has an outer diameter that is at least equal to the outer diameter of the inner lead part 327. The bulge 329 is formed by, for example, soldering together the inner lead part 327 and the outer lead part 328.

Providing the bulge 329 on the lead wire 326 of the electrode 322 enables keeping a constant dimension from the bulge 329 to the electrode main body 324. Specifically, reducing the gap between the bottom of the electrode main body 324 and the inner surface of the facing glass bead 44 (for example, to approximately 0.5 mm) enables lengthening an effective emission length of the lamp.

Note that although the bulge 329 is formed from the same nickel material as the outer lead part 328, the formation is not limited to this. The bulge 329 may be an Fe—Ni alloy, a Cu—Ni alloy, Dumet (dual metal), etc.

The inner lead part 327 has a substantially circular cross section, and has, for example, a total length of 3 mm and a wire diameter of 0.8 mm. Also, the inner lead part 327 has been inserted into a through-hole 44a and sealed therein so that an end on the bulge 329 side contacts (or substantially contacts) the end surface of the glass bead 44. The end opposite to the outer lead part 328 side has been joined to an outside surface of the bottom 322a of the electrode main body 322 in a substantially central position.

The outer lead part 328 and the bulge 329 are protrusions that protrude in a central axial direction from the outer surface of the glass bulb 21 and are joined to the covering 125 via the heat dissipater 128. This structure constitutes the feeder 124. The horizontal section of the outer lead part 328 and the bulge 329 is substantially circular, the total length of both in the central axial direction is, for example, 1 mm, and the central axis of the outer lead part 328 substantially matches the central axis of the end of the glass bulb 21.

In view of the total size of the lamp, the total length of both the outer lead part 328 and the bulge 329 in the central axial direction is, preferably, 1 mm or less. Also, in view of parts cost and breakage of the portion where the glass bead 44 and the inner lead part 327 are sealed (hereinafter referred to as the “sealed portion”), the outer diameter of the bulge 329 is preferably between 1.5 times and 4 times the outer diameter of the inner lead part 327.

As described above, it is preferable for the outer diameter of the glass bulb 21 to be within the range of 1.8 mm to 6.0 mm in order to make the lamp 320 longer and thinner, and in the lamp 320 having this size, the total length in the central axial direction of the outer lead part 328 and the bulge 329 preferably does not project out from the heat dissipater 128, in other words, is preferably a length that is buried within the heat dissipater 128.

This structure can prevent bending of the outer lead part 328 and breakage of the sealed portion between the glass bead 44 and the inner lead part 327, when the outer lead part 328 comes into contact with a surrounding member. Also, if contact occurs with the backlight housing or a socket or the like in the backlight housing when mounting the lamp 320 to the backlight unit, the risk of bending the outer lead part 328 and of breaking the glass bead 44 due to stress exerted on the outer lead part 328 at that time is small.

Also, if the outer lead part 328 comes into contact with an external part before being covered by the heat dissipater 128, since both ends of the glass bulb 21 absorb the force exerted on the bulge 329, this structure prevents leaks resulting from breakage of, for example, the glass bead 44, to which the inner lead part 327 is sealed.

3. Covering, Heat Dissipater and Electrode

In embodiment 2, the heat dissipater 128 fills the sleeve-shaped covering 125 such that the electrode 28 is buried within, and the electrode includes one lead wire. However, other structures may be used. Another structure is described below as another variation.

(1) Variation 4

FIG. 17 is an enlarged view showing an end of a lamp 340 pertaining to variation 4.

Similarly to the embodiments etc., the lamp 340 pertaining to variation 4 includes a glass bulb 342, an electrode 344, a heat dissipater 343 and a covering 345.

The cross section of the glass bulb 342 is circular, and has an outer diameter of 4 mm, an inner diameter of 3 mm, and a thickness of 0.5 mm, for example. An end of the glass bulb 342 is a sealed part 342a that has been pinch-sealed for attachment of the electrode 344.

Note that a phosphor layer has been formed on an inner surface of the glass bulb 342, and mercury, rare gases and the like are enclosed in the interior.

The electrode 344 is a so-called hollow-type electrode, includes an electrode main body 348 and a lead wire 350, and is sealed to the sealed part 342a of the glass bulb 342.

The electrode main body 348 is made of nickel (Ni), and has the shape of a bottomed tube. Note that the material of the electrode main body 348 is not limited to nickel, and for example, niobium (Nb), tantalum (Ta), or molybdenum (Mo) may be used.

The electrode main body 348 has, for example, a total length of 5.2 mm, an outer diameter of 2.7 mm, an inner diameter of 2.3 mm, and a thickness of 0.2 mm. The electrode 344 is arranged so that the central axis of the electrode main body 348 is substantially aligned with the central axis of an end of the glass bulb 21, and the interval between the outer circumferential surface of the electrode main body 348 and the inner circumferential surface of the glass bulb 342 is substantially uniform across the entire area of the outer circumference of the electrode main body 348.

The interval between the outer circumferential surface of the electrode main body 348 and the inner surface of the glass bulb 342 is, specifically, 0.15 mm. When the interval is this small, electrical discharge cannot occur in this narrow space, and thus occurs only in the interior of the electrode main body 348. Accordingly, sputtered material dispersed by the electrical discharge does not easily attach to the inner surface of the glass bulb 342, thereby extending the life of the lamp 340.

At the same time, since the space is narrow and electrons and the like cannot pass behind the electrode 348, or in other words, cannot flip around to the lead wire 350 side at the time of discharge, the lead wire 350 is not readily heated by electron sputter and the like.

Note that the interval between the outer circumferential surface of the electrode main body 348 and the inner surface of the glass bulb 342 does not need to be 0.15 mm. However, it is preferable for the interval to be 0.2 mm or below in order to prevent discharge from entering the interval.

The lead wire 350 is a continuous wire composed of an inner lead part 352 made of tungsten (W) and an outer lead part 354 made of nickel that readily attaches with use of solder or the like. The junction between the inner lead part 352 and the outer lead part 354 substantially matches and becomes one surface with the outer surface of the glass bulb 342. Thus, the inner lead part 352 is located farther inward than the outer surface of the glass bulb 342, and the outer lead part 354 is located farther outward than the outer surface of the glass bulb 342.

The inner lead part 352 has a substantially circular cross section, and has, for example, a total length of 3 mm and a wire diameter of 0.8 mm. The end of the inner lead part 352 on the side nearest to the outer lead part 354 is sealed to the sealed part 342a of the glass bulb 342, and the end on the side farthest from the outer lead part 354 is joined to a substantially central part of the outer surface of the bottom of the electrode main body 23.

The heat dissipater 343 is inside the sleeve-shaped covering 345, and has been provided in the remaining space from the end surface of the glass bulb 342 to the outer edge of the covering 345. The heat dissipater 343 is constituted from solder, and has been pre-shaped (in a shape conforming to the remaining space).

In the heat dissipater 343, a through-hole 343a for the outer lead part 354 of the electrode 344 has been formed at a position corresponding to the central axis of the outer lead part 354, and the outer lead part 354 has been inserted into the through-hole 343a.

The outer lead part 354 has been joined to the heat dissipater 343 by a projection that protrudes from an outer surface of the glass bulb 342 along the central axial direction. The outer lead part 354 has a total length of 1 to 10 mm, and is for example 2 mm, and the central axis of the outer lead part 354 is substantially in alignment with the central axis of the glass bulb 342.

The covering 345 has a sleeve shape and is composed of an iron-nickel alloy.

If the total length of the outer lead part 354 exceeds 10 mm, a crack could form on the sealed part 342a of the glass bulb 342 due to stress from the outer lead part 354, and in order to achieve the function of the outer lead part 354, the total length must be at least 1 mm. Also, a cross section of the outer lead part 354 is substantially circular, and the wire diameter is thinner than that of the inner lead unit 352, for example, 0.6 mm.

Note that in variation 4 also, the feeder 346 has been formed by connecting the covering 345 to the lead wire 350 via the heat dissipater 343.

In the above structure, an end of the glass bulb 342 has been directly inserted into the covering 345, and the outer lead part 354 and the covering 345 are electrically connected via the heat dissipater 343 that exists in the remaining space of the covering 345. Even if the heat dissipater 343 comes into contact with the glass bulb 342 and stress is exerted on the glass bulb 342 due to the difference in coefficient of thermal expansion between the heat dissipater 343 and the glass bulb 342, and while the lamp is lit, cracks do not readily form in the glass bulb 342, since unlike patent document 1, the heat dissipater is not covering the side surface of the glass bulb.

Also, when the length L between an outward end surface of the feeder 346 (covering 345) shown in FIG. 17 and the end surface of the glass bulb 342 increases, the surface area of the feeder 346 (the covering 345) increases and the dissipation characteristic improves. Specifically, the length L is preferably, for example, longer than the outer diameter R of the glass bulb 342.

Following is a description of a manufacturing method for the lamp 340.

First, the glass bulb 342, the heat dissipater 343, and the covering 345 are prepared.

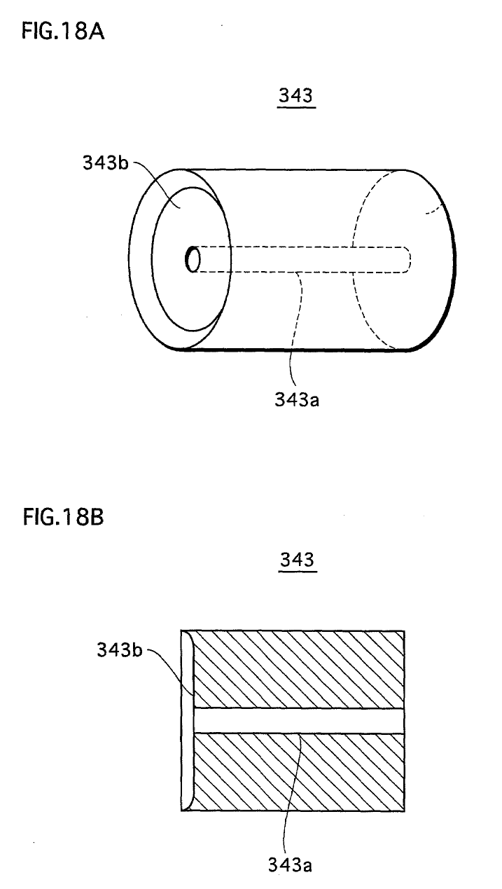

FIG. 18 shows a structure of the heat dissipater 343.

As shown in FIG. 18, the heat dissipater 343 is columnar, and one end thereof has a depression conforming to the shape of the end surface of the glass bulb 342, and the through-hole 343a has been formed in a position corresponding to the central axis of the heat dissipater 343.

Following is a description of a manufacturing method for the heat dissipater 343.

First, columnar solder is formed. At this time, the outer diameter of the columnar solder substantially equals the inner diameter of the covering 345. Then, the columnar-shaped through-hole 343a that has a diameter substantially equal to the wire diameter of the outer lead part 354 is formed along the central axis of the columnar solder (the columnar solder axis and the through-hole axis substantially match). Furthermore, one end surface of the columnar solder is (mechanically) processed (forming step) to conform to the end surface of the glass bulb. In this way, the heat dissipater 343 can be acquired.

Following is a description of a process for mounting the covering 345.

After the end of the glass bulb 342 (342a) has been inserted from one end of the covering 345 to the middle thereof, for example by heating and inserting the covering 345 (heat-fitting), the outer lead part 354 of the electrode 344 is inserted into the through-hole 343a of the heat dissipater 343 while the heat dissipater 343 is inserted into the covering 345 until the end surface 343b of the heat dissipater 343 comes into contact with the end surface of the glass bulb 342.

Lastly, heat is applied to a substantially central portion of the covering 345 in the axial direction (a position corresponding to where the glass bulb 342 and the heat dissipater 343 are in contact with each other). Then, the heat melts a portion of the heat dissipater 343, which is made of solder, that is near the end of the glass bulb 342, thereby attaching (affixing) the heat dissipater 343 and the glass bulb 342 together.

At this time, the end surface 343b located on the glass bulb 342 side of the heat dissipater 343 has a shape conforming to the end surface of the glass bulb 342, and, since the end of the heat dissipater 343 on the glass bulb side (at least including the end surface) has been melted, solder enters a narrow gap between the end surface of the glass bulb 342 and the covering 345, thereby forming contact between the end surface 343b of the heat dissipater 343 and the end surface of the glass bulb 342 (contact process).

In the lamp 340, obtained by the above manufacturing method, the glass bulb 342 is inserted directly into the covering 345, and the outer lead part 354 and the covering 345 are electrically connected via the heat dissipater 343 in the remaining space in the covering 345.

For this reason, since contact between the heat dissipater 343 and the glass bulb 342, if occurring, only occurs on the end surface of the glass bulb 342, even if stress is exerted on the glass bulb 342 due to a difference in coefficient of thermal expansion between the heat dissipater 343 and the glass bulb 342, cracks do not readily form in the glass bulb 342.

Also, since the heat dissipater 343 is provided so as to be in close contact with an end surface of the glass bulb 342, the heat released from the electrode main body 348 is conducted to the covering 345 via the glass bulb 342, the lead wire 350, the heat dissipater 343, etc., and ultimately dissipates from the covering 345 into the atmosphere, thus achieving a high degree of heat dissipation.

Note that the heat dissipater 343 can also be formed by pouring melted solder into a metal cast in the shape of the heat dissipater 343, i.e. by casting.

(2) Other Examples

Aside from variation 4 described above, other examples in which the heat dissipater is provided in the feeder are also possible.

(2-1) Variation 4-1

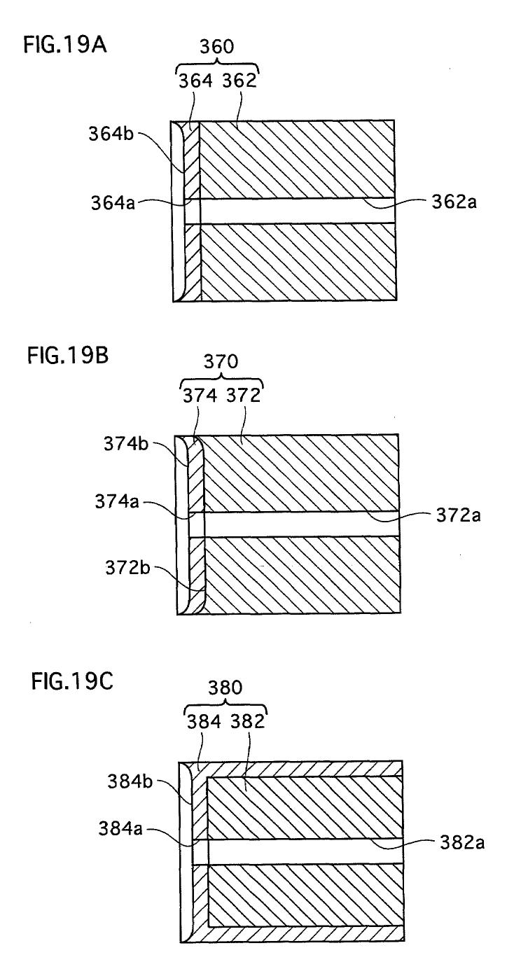

FIG. 19A shows a heat dissipater 360 of variation 4-1.

As shown in FIG. 19A, the heat dissipater 360 pertaining to variation 4-1 is composed of a body 362 and a solder 364. The body 362 is, for example, composed of copper, and is shaped as a column having a through-hole 362a in a substantially central position, which is provided for insertion of a lead wire.

The solder 364 is joined to one end surface of the body 362 (in FIG. 19A, the left side end surface). The solder 364 is disc-shaped, and has the through-hole 364a in the center thereof, and a surface 364a on the opposite side, which is the joint surface between the solder 364 and the body 362, has a shape corresponding to the shape of the end surface of the glass bulb.

Following is a brief description of the attachment of the heat dissipater 360 and the sleeve-shaped covering to the glass bulb.

First the covering is attached to the end of the glass bulb with use of, for example, heat-fitting.

Next, the heat dissipater 360 is inserted into the covering until a surface 364b of the solder 364 touches the end surface of the glass bulb. At this time, since the surface 364b of the solder 364 has a shape that substantially conforms to the end surface of the glass bulb, the solder 364, that is, the heat dissipater 360, comes into close contact with the end surface of the glass bulb (or the portion to be attached expands).

In this state, heat is applied from the end surface of the body 362 and the outer circumference of the covering until the solder 364 reaches a melting temperature. The application of heat is stopped when the solder 364 melts, and the solder cools naturally.

Attaching the covering and the heat dissipater 360 to the glass bulb with use of this method enables improvement of the dissipation characteristic, since melted solder enters the narrow space formed between the end surface of the glass bulb and the covering, and the heat dissipater 360 is attached to the glass bulb with no space therebetween.

The structure shown in FIG. 19A has the advantage that heat for melting the solder is easily conducted to the solder 364, which is a junction to the glass bulb, by applying heat to the body 362 when the glass bulb and the heat dissipater are joined in the manufacturing process.

(2-2) Variation 4-2

FIG. 19B shows the heat dissipater 370 of variation 4-2.

As shown in FIG. 19B, the heat dissipater 370 pertaining to variation 4-2 includes a body 372 and a solder film 374. Similarly to variation 4-1, the body 372 has a columnar shape, and one side surface 372a (in FIG. 19B, the left side) of the body 372 has a shape corresponding to the shape of the glass bulb end surface.

The solder film 374 is applied to the end surface 372a of the body 372. Since the solder film 374 is applied to the end surface 372a of the body 372 at a substantially even thickness, the surface 374 of the solder film 374a has a shape conforming to the end surface of the glass bulb. Note that the attachment of the heat dissipater 370 and the sleeve-shaped covering to the glass bulb is similar to variation 4-1 above.

Similarly to the structure shown in FIG. 19A, the structure shown in FIG. 19B has the advantage that heat for melting the solder is easily conducted to the solder 374, which is a junction to the glass bulb, by applying heat to the body 372 when the glass bulb and the heat dissipater 370 are joined in the manufacturing process. Also, merely by applying the solder film 374 at an even thickness to the end surface 372a of the body 372, and pressing the body 372 on the glass bulb end side when the solder film 374 melts, the surface 374a of the solder 374 conforms to the end surface of the glass bulb, and the contact area between the heat dissipater and the glass bulb can be increased. Of course, the manufacturing process can also be simplified.

(2-3) Variation 4-3

FIG. 19C shows a heat dissipater 380 of variation 4-3.

As shown in FIG. 19C, the heat dissipater 380 pertaining to variation 4-3 includes a body 382 and a solder film 384. Similarly to variation 4-1, the body 382 is a copper column, and one end surface of the body 382 (in FIG. 19C, the left side) and the side surface thereof are covered by the solder film 384. The surface 384b of the solder film 384 that is to touch the end surface of the glass bulb is pre-fabricated (formed) to conform to the glass bulb end surface.

The attachment of the heat dissipater 370 and the sleeve-shaped covering to the glass bulb is similar to variation 4-1, and an effect similar to the effect described in variations 4-1 and 4-2 can be obtained by the structure shown in FIG. 19C.

(3) Variation 5

Although in variation 4, as shown in FIG. 17, the lamp 340 is formed with use of the sleeve-shaped feeder 346 and the heat dissipater 343 that is made of solder, the lamp may have another structure. Another structure is described below as variation 5. Note that in the following description, a “feeder terminal” is composed of a covering and a heat dissipater.

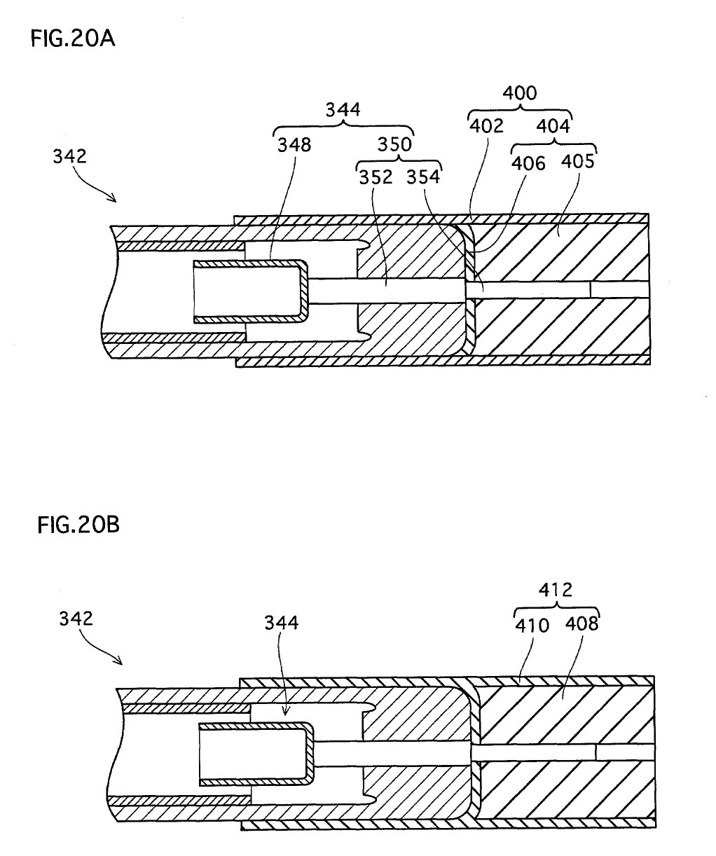

FIGS. 20A and 20B are enlarged sectional views of an end of a lamp pertaining to variation 5.

As shown in FIG. 20A, a feeder terminal 400 pertaining to variation 5 is composed of a covering 402 and a heat dissipater 404, and is attached to the end of the glass bulb 342. The heat dissipater 404 includes a conductor plate 406 and a solder 405.

The conductor plate 406 is composed of, for example, the same iron nickel alloy composing the covering 402. The outer diameter of the conductor plate 406 is substantially equal to the inner diameter of the covering 402, and a surface 406a touching the glass bulb 342 conforms to the end surface of the glass bulb 342.

Following is a description of a process for mounting the feeder terminal 400 to the glass bulb 342. First, the end of the glass bulb 342 is inserted into the covering 402 to a predetermined length. Next, the outer lead part 354 is inserted through the through-hole 406b in the conductor plate 406, and then the solder 405 is inserted into the covering 402 until the conductor plate 406 comes into contact with the end surface of the glass bulb 342.

The glass bulb 342 is disposed such that the axis thereof is disposed vertically, and solder in a melted state (hereinafter referred to as “melted solder”) (this becomes the solder 405) flows in the space that is separated by the inner wall of the covering 402 and the conductor plate 406. Since the covering 402 and the conductor plate 406 have a high coefficient of thermal conductively and reach a high temperature due to heat from the melted solder, the melted solder flows into the narrow space formed between the covering 402 and the conductor plate 406.

This structure improves the efficiency of thermal conductivity from the glass bulb 342 to the conductor plate 406 since the conductor plate 406 is in contact with the glass bulb 342. Accordingly, the heat emitted from the electrode main body 348 is released into the atmosphere from the covering 402 and the solder 405 which connect with the conductor plate 406, as a result, increasing the lamp's dissipation characteristic.

Although not described in the present variation, for example, a plurality of through-holes may be formed in the conductor plate 406. Since the melted solder flows into the through-holes during the forming process, the seal between the conductor plate 406 and the end of the glass bulb 342 improves, and the thermal conductivity effect from the glass bulb 342 to the conductor plate 406 increases. Note that the through-holes preferably have a diameter that is 3 mm or less and that for example, a plurality of through-holes are formed, each of which is approximately 0.5 mm.

Also, the covering 402 and the conductor plate 406 shown in FIG. 20A may be soldered together as shown in FIG. 20B. The covering 410 may include a tube and a conductor plate integrally formed as one piece, and the feeder 412 may be constituted from such covering 410 and the solder 408. Note that in this case, the covering 410 corresponds to the heat dissipater pertaining to the present invention.

(4) Variation 6

Although the covering of the above embodiments and variations mainly has a sleeve shape, other shapes may also be used. Another shape is described below as variation 6.

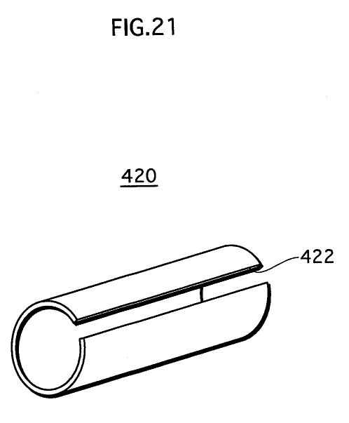

FIG. 21 is a perspective view of a covering 420 pertaining to variation 6.

The covering 420 pertaining to the present variation is, for example, a flat sheet that has been rounded to form a shape such that the ends do not meet. In other words, the tube has a slit 422 along the lengthwise direction in a portion of the circumferential direction (thus a cross section taken perpendicular to a lengthwise direction forms a C-shape).

Providing a feeder terminal on the end of the glass bulb with use of the covering 420 is thought to have the effect of suppressing the formation of air bubbles in the gap between the glass bulb and the heat dissipater, since air bubbles are emitted from the slit 422 when connecting the covering 420 and the lead wire with use of a heat dissipater composed of, for example, solder. Note that if a sleeve-shaped feeder not having a slit is used, the air bubbles are sucked out in a vacuum atmosphere or the like in the gap.

4. Backlight Unit

(1) Structure

The backlight units described in the above embodiments store the lamps 20 and 120 in the housings 10 and 110, and are direct-type backlight units in which the lamps 20 and 120 directly illuminate the liquid crystal image units 11. However, other types of backlight units may be used. Specifically, an edge type that provides a lamp on an edge of a light guide plate, where light from the lamps reflects off of the light guide plate to irradiate a liquid crystal panel may be used. Note that lamps in an edge-type backlight unit may be straight tubes, or may have an L-shape that conforms to abutting edges of the light guide plate.

(2) Variation 7

Although in the lighting circuit 160 of embodiment 2, two adjacent lamps have a phase difference of substantially 180 degrees, for example, the same phase of sine-wave current may be provided to both adjoining lamps. This case is described below as variation 7.

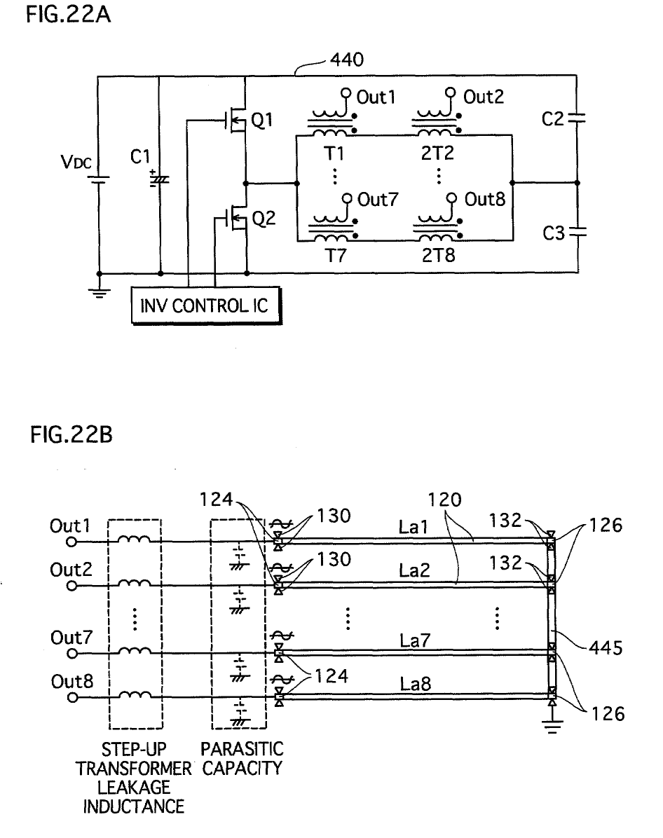

FIG. 22A shows a lighting circuit 440, and FIG. 22B shows connections of the lamps La in the lighting circuit 440.

The lighting circuit 440 has a substantially similar structure to the lighting circuit 160 of embodiment 2. As shown in FIG. 22A, the lighting circuit 440 includes a direct current power source (V_{DC}); switch elements Q1, Q2 and capacitors C2, C3 that are connected to the direct current power source (V_{DC}); step-up transformers T1 and 2T2 (or step-up transformers T7 and 2T8) that connect the connections between the switch element Q1 and the switch element Q2, the condenser C2 and the condenser C3; and an inverter control IC that supplies a gate signal for flipping switch elements Q1, Q2 ON and OFF alternately.

In the lighting circuit 160 of embodiment 2, the secondary-side transformer connection orientations of the two step-up transformers 2T2 and 2T8 differ from each other. This enables supplying sine-wave currents having the same phase to two adjacent lamps.

Following is a description of the lamp connection with reference to FIG. 22B.

In variation 7, similarly to embodiment 2, a feeder is provided on the end of a glass bulb, and attachment to the lamp housing and feeding is performed with use of a socket method. Here, since the lamps, lamp holders, and feeders are the same as embodiment 2, the same reference notations are used in the following description.

A plurality of lamps 120 are connected and held substantially parallel to each other by lamp holders 130 and 132 with a predetermined interval therebetween. Also, the lamp holder 132 that holds the feeder 126 on one side of two adjacent lamps 120 (in FIG. 22B, the feeder 126 of lamps La1 and La2 or La7 and La8) has been connected to the grounded side.

Also, the lamp holders 130 that connect and hold feeder 124 on the other side of two adjacent lamps 120 (in FIG. 22B, the feeder 124 of lamps La1, La2, La7, and La8) are connected on the high-voltage side of the lighting circuit 440.

Since the same effect as embodiment 2 can be obtained by this structure, a voltage phase difference is substantially zero degrees, voltage-potential differences having the same potential are applied to two adjacent lamp holders 130, and the interval between two adjacent lamps 120 can be smaller than in a case in which the voltage phase difference is substantially 180 degrees.

Note that in order to make the voltage phase difference substantially zero degrees and to further reduce harness processing, the lamp holders 132 that connect and hold the feeder 126 on one side of the plurality of lamps La1 through La8, for example, are all grounded. As shown in FIG. 22B, this grounding is performed by soldering each one of the U-shaped lamp holders 132 to the metal substrate 445.

5. Lamp Shape, Etc.

Although the lamps described in the embodiments are straight-tube-shaped, other shapes may be used, for example, a U-shape, a C-shape having three straight sides, or a W-shape.

The outer diameter of the lamps is preferably 5 mm or less. This is because, the thinner the lamp, the thinner the electrode becomes, and the higher the electrode temperature rises when the lamp is lit. In particular, this is because if the outer diameter is 5 mm or less, reduction in the life of the lamp and the decrease in lamp efficiency becomes significant, thereby requiring an improvement in the dissipation characteristic of the electrode.

Also, although the cross section of the lamp in the embodiments, etc. is substantially circular, other shapes may be used. A lamp having another shape is described below as variation 8.

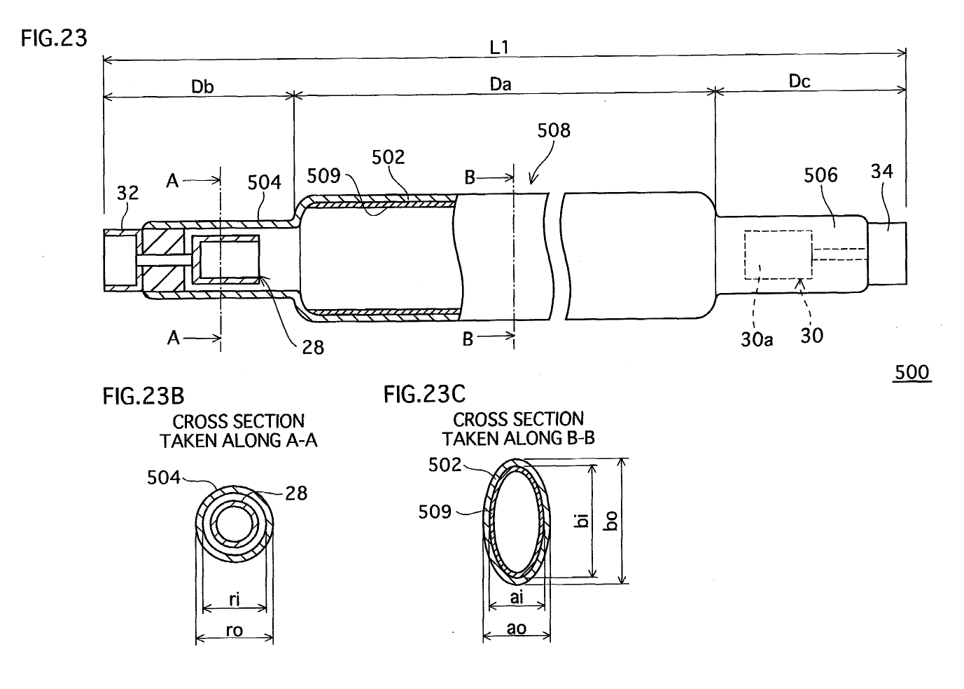

FIG. 23 shows an outline of a lamp 500 pertaining to variation 8.

As shown in FIG. 23, the lamp 500 includes a glass bulb 508 formed by sealing both ends 504 and 506 of a glass tube 502 whose cross section is oval, electrodes 28 and 30 that are respectively attached to the ends 504 and 506 of the glass bulb 508, and heat dissipaters 32 and 34 provided on the electrodes 28 and 30 of an external portion of the glass bulb 508.

Note that the electrodes 28 and 30 and the heat dissipaters 32 and 34 of the lamp 500 have a similar structure to embodiment 1 except for the glass bulb 508.

The glass tube 502 that constitutes the glass bulb 508 has a cross section that is oval, as shown in FIG. 23C. As shown in FIG. 23B, the cross section of both ends 504 (506), is substantially circular. The central portion here refers to at least a light-extracting portion (a flattened portion in an area between the tips of the electrode main bodies 28a and 30a arranged at the ends of the glass bulb 508) in the positive column emission portion of the glass bulb 508 (substantially in the area where the positive column is emitted). Note that the phosphor layer 509 has been formed in a part corresponding to the light-extracting portion of the glass bulb 508.

The measurements of the lamp 500 are given below. The total length L1 of the lamp 500 is 705 mm, the length Da of the positive column emission portion is approximately 680 mm, the lengths Db and Dc of circular portions on the electrode part sides are approximately 12 mm each, and the outer circumferential surface area of the positive column emission portion is approximately 105 cm².

Also, as shown in FIG. 23C, the substantial oval has an external minor axis ao of 4.0 mm, an internal minor axis ai of 3.0 mm, an external major axis bo of 5.8 mm, and an internal major axis bi of 4.8 mm. Also, as shown in FIG. 23B, the substantially circular tube outside diameter ro is 5.0 mm, and the tube inner diameter ri is 4.0 mm.

Flattening the cross section of the light-extracting portion of the glass bulb 508 suppresses an extreme rise in temperature of the coldest temperature by making the outer circumference surface area greater than in a conventional straight tube lamp. Furthermore, the external minor axis ai that has a flat shape is shorter than in a conventional straight tube lamp that has a tube inner diameter similar to the internal major axis bi, thereby enabling effectively keeping a short distance from a center of a positive column plasma space to an inner wall of a tube. Thus, this structure suppresses a decrease in light emission efficiency even if the lamp current is higher than in a conventional lamp.

### INDUSTRIAL APPLICABILITY

A cold cathode fluorescent lamp pertaining to the present invention can be used as a light source for thin and large-screen backlight units, and a backlight unit pertaining to the present invention can be used in thin and large-screen display apparatuses.

1. A cold cathode fluorescent lamp comprising:
a glass bulb;
an electrode including an electrode main body and a lead wire, a portion of the lead wire having been sealed to an end of the glass bulb while the electrode main body is positioned in an interior of the glass bulb; and
a heat dissipater provided on an other portion of the lead wire outside the glass bulb so as to, when viewed externally along an extending direction of the lead wire, surround the lead wire and be in contact with an outer surface of the end of the glass bulb, wherein
a lamp current value is in a range of 5 mA to 12 mA, inclusive.

2. The cold cathode fluorescent lamp of claim 1, wherein
the heat dissipater is tubular in shape, an end thereof being closed, and an outer surface of the closed end being substantially in surface contact with the outer surface of the end of the glass bulb.

3. The cold cathode fluorescent lamp of claim 1, wherein
the heat dissipater is columnar in shape, and an end thereof being in surface contact with the outer surface of the end of the glass bulb.

4. The cold cathode fluorescent lamp of claim 1, wherein
the heat dissipater is composed of a conductive material.

5. The cold cathode fluorescent lamp of claim 4, wherein
the lead wire and the heat dissipater are integrally formed as one piece.

6-17. (canceled)

18. A backlight unit comprising:
a plurality of cold cathode fluorescent lamps as a primary light source;
a housing that stores the cold cathode fluorescent lamps;
a plurality of U-shaped lamp holders provided in the housing, each gripping an outer circumference of a different end of the plurality of cold cathode fluorescent lamps; and
a lighting circuit for lighting the plurality of cold cathode fluorescent lamps, wherein
each of the cold cathode fluorescent lamps is the cold cathode fluorescent lamp of claim 21,
each of the lamp holders is electrically connected to the respective one of the cold cathode fluorescent lamps by gripping an outer circumference of a coating thereof, and
the cold cathode fluorescent lamps have been gripped by the lamp holders so as to be arranged substantially parallel with an interval between two adjacent ones of the cold cathode fluorescent lamps, and a pair of lamp holders that grip the coatings of the two adjacent cold cathode fluorescent lamps arranged substantially parallel are electrically connected to each other.

19. (canceled)

20. A cold cathode fluorescent lamp, comprising:
a glass bulb;
an electrode including an electrode main body and a lead wire, a portion of the lead wire having been sealed to an end of the glass bulb while the electrode main body is positioned in an interior of the glass bulb; and
a heat dissipater provided on an other portion of the lead wire outside the glass bulb so as to, when viewed externally along an extending direction of the lead wire, surround the lead wire and be in contact with an outer surface of the end of the glass bulb, wherein
an interval of 0.2 mm or less exists between an outer circumferential surface of the electrode main body and an inner surface of the glass bulb.

21. A cold cathode fluorescent lamp, comprising:
a glass bulb;
an electrode including an electrode main body and a lead wire, a portion of the lead wire having been sealed to an end of the glass bulb while the electrode main body is positioned in an interior of the glass bulb; and
a heat dissipater provided on an other portion of the lead wire outside the glass bulb so as to conduct electricity and be electrically connected to the lead wire, wherein
a conductive coating has been provided around the end of the glass bulb, the conductive coating being electrically connected to the heat dissipater.

22. The cold cathode fluorescent lamp of claim 21, wherein
a face of the heat dissipater facing the glass bulb conforms in shape to the outer surface of the end of the glass bulb, and is in contact with the face of the glass bulb.

23. The cold cathode fluorescent lamp of claim 21, wherein
the heat dissipater is composed of solder.

24. The cold cathode fluorescent lamp of claim 22, wherein
the heat dissipater includes a first member composed of solder and a second member composed of a conductor other than solder, the second member being joined to the first member, and
the first member includes the face of the heat dissipater that conforms in shape to the outer surface of the end of the glass bulb.

25. The cold cathode fluorescent lamp of claim 22, wherein
the heat dissipater includes a conductor plate composed of a conductor other than solder, and a solder body that is joined to the conductor, and
the conductor plate includes the face of the heat dissipater that conforms in shape to the outer surface of the end of the glass bulb on a side of the conductor plate that is opposite from the solder.

26. The cold cathode fluorescent lamp of claim 25, wherein
a plurality of through-holes have been formed in the conductor plate.

27. The cold cathode fluorescent lamp of claim 21, wherein
the lead wire and the heat dissipater have been disposed with an interval therebetween, and are electrically connected to each other via solder, and
the solder has a property of melting down in a case of a flow of overcurrent due to joule heat.

28. The cold cathode fluorescent lamp of claim 27, further comprising:
an insulation member that hermetically seals an area in the solder around connection portions between the lead wire and the heat dissipater.

29. The cold cathode fluorescent lamp of claim 28, wherein
the insulation member is a rosin.

30. The cold cathode fluorescent lamp of claim 1, wherein
the lead wire includes a bulge having a larger outer diameter than an outer diameter of the lead wire, and
the bulge has been disposed so as to be in contact with the outer surface of the end of the glass bulb.

31. A backlight unit including
the cold cathode fluorescent lamp of claim 1 as a primary light source.

32. A backlight unit comprising:
a plurality of cold cathode fluorescent lamps as a primary light source;
a housing that stores the cold cathode fluorescent lamps;
a plurality of U-shaped lamp holders provided in the housing, each gripping an outer circumference of a different end of the plurality of cold cathode fluorescent lamps; and
a lighting circuit for lighting the plurality of cold cathode fluorescent lamps, wherein
each of the cold cathode fluorescent lamps is the cold cathode fluorescent lamp of claim 21,
each of the lamp holders is electrically connected to the respective one of the cold cathode fluorescent lamps by gripping an outer circumference of a coating thereof, and
the cold cathode fluorescent lamps are held by the lamp holders substantially parallel to two adjacent ones of the cold cathode fluorescent lamps with an interval therebetween, and a pair of lamp holders that hold the coatings of the two adjacent cold cathode fluorescent lamps arranged substantially parallel are electrically connected to each other on a grounded side, and a pair of the lamp holders that are in contact with the coatings at another end of the two adjacent ones of the cold cathode fluorescent lamps are connected to a high-voltage side of the lighting circuit.

33. A liquid crystal display apparatus that includes the backlight unit of claim 31.
